(19) United States
(12) Patent Application Publication
(10) Pub. No.: US 2008/0307960 A1
(43) Pub. Date: Dec. 18, 2008

(54) Air Pollutant Removal Using Magnetic Sorbent Particles

(76) Inventors: David W. Hendrickson, Hibbing, MN (US); Iwao Iwasaki, Grand Rapids, MN (US); David J. Englund, Bovey, MN (US); Thomas R. Larson, Montgomery, TX (US); Blair R. Benner, Grand Rapids, MN (US); Donald R. Fosnacht, Hermantown, MN (US); John Engesser, Grand Rapids, MN (US)

Correspondence Address: MUETING, RAASCH & GEBHARDT, P.A., P.O. BOX 581336, MINNEAPOLIS, MN, 55458-1336, US

(21) Appl. No.: 11/886,019

(22) PCT Filed: Mar. 13, 2006
(86) PCT No.: PCT/US06/09375

§ 371 Date: Aug. 6, 2008

Related U.S. Application Data
(60) Provisional application No. 60/660,808, filed on Mar. 11, 2005.
(60) Provisional application No. 60/720,155, filed on Sep. 23, 2005.

(51) Int. Cl. B01D 53/02; B01J 20/00; B01J 20/02; B01J 20/22; B32B 1/00

(52) U.S. Cl. 95/28; 96/1; 502/400; 502/406; 502/401; 502/411; 502/415; 428/402

(57) ABSTRACT

Absorbent magnetic particles are used to remove air pollutants. The adsorbent magnetic particles can adsorb various air pollutants, including nitrogen oxides, sulfur oxides, and mercury, and may be regenerated for reuse.

This application claims the benefit of U.S. Provisional Application No. 60/660,808, filed Mar. 11, 2005, and U.S. Provisional Application No. 60/720,155, filed Sep. 23, 2005, which are incorporated by reference herein.

### GOVERNMENT FUNDING

The present invention was made with government support under Grant No. 06-79-04560, awarded by the USEDA. The Government may have certain rights in this invention.

### BACKGROUND

The control of air pollution is an increasingly important international problem. Air pollution has been linked to a number of significant problems such as ozone depletion, global climate change, acid rain, environmental degradation, and health effects in humans, plants, and animals. The problem of controlling air pollution is expected to continue to increase in importance as general population growth continues and energy expenditures increase in developing countries.

Air pollution is created by a number of different types of sources, and exists in a number of different forms. Sources of air pollution are generally categorized as area sources, mobile sources, and point sources. Area sources include small pollution sources like dry cleaners, gas stations, and auto body paint shops, and are defined as sources that emit less than 10 tons per year of criteria pollutants or hazardous air pollutants. Mobile sources include both on-road vehicles such as cars and off-road equipment such airplanes and construction equipment. Nationwide, mobile sources are responsible for a majority of carbon monoxide pollution and a majority of nitrogen oxide pollutants. Point sources include major industrial facilities like chemical plants, steel mills, oil refineries, power plants, and hazardous waste incinerators. Point sources are defined as those that emit 10 tons per year of criteria pollutants or hazardous air pollutants. Nationwide, point sources like power plants, petroleum refineries, fertilizer manufacturers, industrial paper mills, copper smelters and iron and steel mills contribute the majority of sulfur dioxide emissions. Point sources, predominantly electrical utilities and industrial boilers, are also major emitters of nitrogen oxides.

Air pollutants have been categorized by regulatory agencies into two basic classes; criteria pollutants and hazardous air pollutants. Criteria pollutants are six particular chemicals that occur frequently in ambient air and can injure human health, harm the environment or cause property damage. The criteria pollutants are carbon monoxide, lead, nitrogen oxides (NO_{X}), ozone, particulate matter, and sulfur oxides (SO_{X}). Nitrogen oxides include nitric oxide (NO), nitrogen dioxide (NO₂), and its dimer N₂O₄. Sulfur oxides include sulfur dioxide (SO₂) and sulfur trioxide (SO₃). Hazardous air pollutants (HAPs) refer to a large number of other chemicals that can cause adverse effects to human health or the environment. Over 188 of these pollutants, including substances that cause cancer, neurological effects, respiratory effects, and reproductive effects have been identified. The full list of HAPs is provided by the Environmental Protection Agency (EPA), Office of Air Quality, Planning & Standards, in section 112: Hazardous Air Pollutants List.

One of the hazardous air pollutants listed by the EPA is mercury (Hg), which is categorized as a highly dangerous developmental toxicant. Mercury compounds (CAS number EDF-033) are similarly categorized. Many power plants emit daily amounts of up to a pound of mercury and mercury compounds. A common material source of mercury, particularly for point sources, is coal. Mercury is present in coal in a variety of concentrations, which vary greatly. It has been reported that mercury is present in coal in concentrations ranging from 0.02 to 1.8 ppm with an average of 0.11 ppm (Meij, et al., “The Fate and Behavior of Mercury in Coal-Fired Power Plants”, Journal of the Air & Waste Management Association, 52, 2002).

Mercury present in a pollution source may exist in a variety of different chemical species, which may have a significant impact on the fate of mercury in air pollution control devices. At the temperatures normally employed in coal burners (e.g., 1500° C.), mercury exists in the gaseous metal state. However, the speciation of mercury after coal burning varies significantly. The speciation of mercury is generally a function of flue gas composition, temperature, time-temperature history, and the air pollution control devices present (Senior, “Behavior of Mercury in Air Pollution Control Devices on Coal-Fired Utility Boilers”, presented at the Power Production in the 21^{st} Century: Impacts of Fuel Quality and Operations, Engineering Foundation Conference, Snowbird, Utah, Oct. 28-Nov. 2, 2001). Consequently, the speciation of mercury is widely variable from plant to plant where few correlations are available. Mercury can exist as several different species including elemental mercury (Hg₀), HgCl₂, HgO, HgSO₄, HgS, as well as several other less stable compounds; however, HgCl₂ has been identified as the major oxidized species (Niksa et al., “Interpreting Laboratory Test Data on Homogenous Mercury Oxidation in Coal-Derived Exhausts,” paper presented at the EPRI-EPA-DOE-AWMA Mega Symposium and Mercury Conference, Chicago, Ill., Aug. 21-23, 2001).

There has been considerable interest in controlling the release of mercury around point sources such as coal-fired power plants due to the high toxicity of this pollutant. Attention has focused on the removal of mercury from flue gases by existing air pollution control devices. Some of the important parameters identified as contributing to the distribution and subsequent removal of mercury include the plant configuration, coal source, chlorine content of the coal, speciation of mercury, and the type of burner. Most coals used in the United States, for example, contain <0.1 part-per-billion/weight of mercury, with large variation yielding flue gas concentrations on the order of 1 to 20 ug/m³ of flue gas.

Conventional air pollution control devices have shown only moderate success in removing mercury from the flue gases of point sources such as coal-fired plants. A useful review of mercury control options for coal-fired power plants is provided by Pavlish et al., “Status review of mercury control options for coal-fired power plants,” Fuel Processing Technology, 82, 89-165 (2003). Conventional air pollution control devices include particulate control devices (PCD) such as electrostatic precipitators, fabric filters, and wet scrubbers. As these devices are designed for removing fine particulates, their mercury removal efficiencies depend largely on the percentage of particulate bound Hg. Flue gas control devices include flue gas desulfurization (FGD) scrubbers, spray dry adsorbers for SO₂ control, and selective catalytic reduction for NO_{X} control. FGD systems remove a majority of oxidized Hg, but remove very little elemental Hg (Alfonso et al., “Assessment of Mercury Emissions from Full-Scale Power Plants,” Presented at the EPRI-EPA-DOE-AWMA Mega Symposium and Mercury Conference, Chicago, Ill., Aug. 21-23, 2001). European sources report that, on average, only about 50% of the overall mercury is removed by FGD's (Meij et al., “The Fate and Behavior of Mercury in Coal-Fired Power Plants”, Journal of the Air & Waste Management Association, 52, 2002).

The development of sorbents for mercury removal from flue gases is described by Granite et al., “Novel Sorbents for Mercury Removal from Flue Gas,” Ind. Eng. Chem. Res., 39, 1020-1029 (2000). The removal of mercury from flue gases using solid adsorbents is dependent on several parameters including the type of sorbent (e.g., properties of sorbent), temperature, residence time, Hg concentration, and flue gas composition. Several types of mercury sorbents have been tested including several types of activated carbons, including those derived from various precursor material, sulfur impregnated activated carbons, fly ash, calcium based sorbents, various metal oxides, and other inorganic materials. Unfortunately, many of the sorbents that have been developed are expensive and are difficult to reuse. For example, activated carbon sorbents are very costly and must be disposed of as hazardous waste after adsorption of mercury.

Efforts have been made to develop more sophisticated methods of removing mercury and other air pollutants from flue gases. For example, U.S. Patent Application Publication No. 20040109800 by Pahlman et al., published Jun. 10, 2004, and entitled “System and process for removal of pollutants from a gas stream” provides a system for removal of targeted pollutants such as SO_{X}, NO_{X}, mercury compounds, and ash from flue gases using metal oxide sorbents. Another example is provided by WO 2004/064078, published by D. Mazyck and entitled “Magnetic activated carbon and the removal of contaminants from a fluid streams” which uses magnetic activated carbon for the removal of contaminants such as mercury from flue gases. However, these references disclose particles that are difficult to effectively remove from other waste material and may cause one to incur various operational costs such as the need for additional handling apparatus or disposal expenses.

### SUMMARY OF THE INVENTION

In one or more embodiments, an air pollutant removal system effectively removes mercury or other air pollutants using particles that are readily removed from the gas stream and separated from other waste materials, and are inexpensive to produce and use. Also, in one or more embodiments, a method is provided for simply and inexpensively converting existing pollution control systems to improve their capacity for mercury removal.

Accordingly, in one aspect, the present invention provides a particle for use in air pollutant removal, in which the particle includes a magnetic core and a sorbent layer provided on at least a portion of the magnetic core.

In one or more embodiments of the particle, the sorbent layer includes a metal oxide, while in further embodiments the sorbent layer includes a manganese oxide. In other embodiments of the particle, the sorbent layer includes a metal sulfide, while in a further embodiment the sorbent layer includes molybdenum disulfide. In yet another embodiment of the particle, the sorbent layer includes a nanostructured surface with a surface area of about 100 m²/g or more. In some embodiments of the particle, the sorbent layer completely covers the magnetic core.

In other embodiments of the particle, the magnetic core includes iron, while in a further embodiment the magnetic core includes magnetite. In a particular embodiment of particles including a magnetite magnetic core, the sorbent layer includes manganese dioxide and the particle has a nominal diameter of about 100 microns or less. In additional embodiments, the particle includes a binder.

In other embodiments of the particle, the particle has a nominal diameter of about 100 microns or less, while in a further embodiment the particle has a nominal diameter of about 50 microns or less.

Another aspect of the invention provides a method of preparing particles for use in air pollutant removal that includes combining magnetic cores with an aqueous solution including at least one of a metal oxide or metal sulfide to at least partially coat the magnetic cores therewith; and removing the magnetic cores at least partially coated with metal oxide from the aqueous solution.

In one or more embodiments of the method of preparing particles, the aqueous solution further includes a binder, while in further embodiments the binder includes a phosphate binder or sodium silicate.

In additional embodiments of the method of preparing particles, the metal oxide is selected from a group consisting of MnO₂, TiO₂, CuO, CO₃O₄, NiO₂, and Al₂O₃. In another embodiment, the metal sulfide includes molybdenum disulfide.

In additional embodiments of the method of preparing particles, the magnetic cores include magnetite, while in further embodiments the particle has a nominal diameter of about 100 microns or less.

In another aspect, the invention provides a method for using particles to remove pollutants from a gas stream that includes introducing adsorbent magnetic particles into a gas stream, wherein each of a plurality of the adsorbent magnetic particles includes a magnetic core and a sorbent layer covering at least a portion of the magnetic core, wherein the adsorbent magnetic particles associate with pollutants in the gas stream; and removing the adsorbent magnetic particles associated with pollutants from the gas stream. Further embodiments of this method can include one or more of the embodiments of particles that include a magnetic core and a sorbent layer provided on at least a portion of the magnetic core, described herein.

In one or more embodiments of the method of removing pollutants, the pollutants are selected from a group consisting of mercury, sulfur oxides, and nitrogen oxides, while in further embodiments at least 95% of mercury present in the gas stream is removed from the gas stream.

In other embodiments, the method further includes removing non-magnetic waste material from the gas stream, while in further embodiments the method includes magnetically separating the non-magnetic waste material from the adsorbent magnetic particles associated with pollutants. Embodiments of the invention may also include regenerating the adsorbent magnetic particles associated with pollutants. In some embodiments, the non-magnetic waste material includes fly ash.

In additional embodiments, the method includes flowing the gas stream through an adsorbent filter subsequent to removing the adsorbent magnetic particles associated with pollutants from the gas stream.

In a further aspect, the invention provides a system for use in removing pollutants from a gas stream that includes a conduit for receiving a gas stream from a gas stream source; a magnetic particle feeder operable to introduce adsorbent magnetic particles into the gas stream, wherein each of a plurality of the adsorbent magnetic particles includes a magnetic core and a sorbent layer covering at least a portion of the magnetic core, wherein the adsorbent magnetic particles associate with pollutants in the gas stream; and a particle collector operable to remove the adsorbent magnetic particles from the gas stream after one or more adsorbent magnetic particles have associated with a pollutant in the gas stream.

In one or more embodiments of the system, the system further includes an exhaust port that guides the gas stream to the atmosphere after it has passed through the particle collector and an adsorbent filter between the particle collector and the exhaust port, while in some embodiments the adsorbent filter includes a sorbent-coated honeycomb block filter.

In one or more embodiments of the system, the gas stream source includes an exhaust gas stream from a manufacturing or power plant.

Further embodiments of this system can include one or more of the embodiments of particles that include a magnetic core and a sorbent layer provided on at least a portion of the magnetic core, described herein.

In additional embodiments of the system, the particle collector is further operable to remove non-magnetic waste material from the gas stream, while in further embodiments this non-magnetic waste material includes fly ash.

In additional embodiments of the system, the system includes a magnetic separator operably connected to the particle collector, wherein non-magnetic waste material is separated from adsorbent magnetic particles associated with pollutant by the magnetic separator.

Additional embodiments of the system may further include a particle regeneration apparatus operable to separate pollutants from the adsorbent magnetic particles. In some embodiments, the particle regeneration apparatus is operable to separate the pollutants from the adsorbent magnetic particles using at least a heat treatment, while in further embodiments the particle regeneration apparatus is operable to separate the pollutants from the adsorbent magnetic particles using at least an aqueous solution.

In additional embodiments of the system, the particle collector is a bag house, while in yet further embodiments the particle collector is an electrostatic precipitator.

In a further aspect, the invention provides a particle for use in air pollutant removal including a foamed iron oxide, wherein the foamed iron oxide includes a plurality of voids defined therein, and wherein the particle has a nominal diameter of about 100 microns or less.

In one or more embodiments of the particle, the iron oxide includes magnetite. In further embodiments, the particles may include calcium carbonate. In yet further embodiments, the particle includes a sorbent material, while in further embodiments the sorbent material includes a metal oxide or metal sulfide. The sorbent material of the particles may also include at least one of molybdenum disulfide and manganese dioxide.

In one or more embodiments, the particle includes a plurality of voids that occupy 50% or more of the volume of the particle. In additional embodiments, the particle includes iron phosphate.

In another aspect, the invention provides a method of preparing particles for use in air pollutant removal that includes using phosphoric acid and a foaming agent to foam an iron oxide, wherein the foamed iron oxide includes iron phosphate; and forming the foamed iron oxide into foamed particles. In one or more embodiments, the method includes using phosphoric acid and a foaming agent to foam an iron oxide and forming the foamed iron oxide into particles by spray drying the foamed particles, while in other embodiments using phosphoric acid and a foaming agent to foam an iron oxide provides a mass of foamed iron oxide, and forming the foamed iron oxide into particles includes mechanically disrupting the mass of foamed iron oxide.

Further embodiments of this separation method can include one or more of the embodiments of particles that include a foamed iron oxide, wherein the foamed iron oxide includes a plurality of voids defined therein, as described herein.

In additional embodiments of the method, the phosphoric acid and the foaming agent each independently include 25% or less of the total weight when combined with iron oxide.

An additional aspect of the invention provides a method for use in removing pollutants from a gas stream that includes introducing adsorbent magnetic particles into a gas stream, wherein each of a plurality of the adsorbent magnetic particles include foamed iron oxide, wherein the foamed iron oxide includes a plurality of voids defined therein, and further wherein the adsorbent magnetic particles associate with pollutants in the gas stream; and removing the adsorbent magnetic particles associated with pollutants from the gas stream.

Further embodiments of this method can include one or more of the embodiments of particles that include including a foamed iron oxide, wherein the foamed iron oxide includes a plurality of voids defined therein, as described herein.

In additional embodiments of the method of pollutant removal using particles that include a foamed iron oxide, the pollutants are selected from the group consisting of mercury and sulfur oxides, while in further embodiments at least 95% of the mercury present in the gas stream is removed from the gas stream.

In additional embodiments, the method further includes removing non-magnetic waste material from the gas stream. This non-magnetic waste material may include fly ash. Additional embodiments may also include magnetically separating the non-magnetic waste material from the adsorbent magnetic particles associated with pollutants.

One or more embodiments of the invention may include regenerating the adsorbent magnetic particles associated with pollutants.

In additional embodiments, the method may include flowing the gas stream through an adsorbent filter subsequent to removing the adsorbent magnetic particles associated with pollutants from the gas stream.

In another aspect, the invention provides a system for use in removing pollutants from a gas stream that includes a conduit for receiving a gas stream from a gas stream source; a magnetic particle feeder operable to introduce adsorbent magnetic particles into the gas stream, wherein each adsorbent magnetic particle includes foamed iron oxide, wherein the foamed iron oxide includes a plurality of voids defined therein; and a particle collector operable to remove the adsorbent magnetic particles from the gas stream after one or more adsorbent magnetic particles have associated with a pollutant in the gas stream.

One or more embodiments of the system further include an exhaust port that guides the gas stream to the atmosphere after it has passed through the particle collector and an adsorbent filter between the particle collector and the exhaust port, while in further embodiment the adsorbent filter includes a sorbent-coated honeycomb block filter.

In additional embodiments, the gas stream source of the system includes an exhaust gas stream from a manufacturing or power plant.

Further embodiments of this system can include one or more of the embodiments of particles that include a foamed iron oxide, wherein the foamed iron oxide includes a plurality of voids defined therein, as described herein.

In additional embodiments of the system, the particle collector is further operable to remove non-magnetic waste material from the gas stream, while in further embodiments this non-magnetic waste material includes fly ash.

In additional embodiments of the system, the system includes a magnetic separator operably connected to the particle collector, wherein non-magnetic waste material is separated from adsorbent magnetic particles associated with pollutant by the magnetic separator.

Additional embodiments of the system may further include a particle regeneration apparatus operable to separate pollutants from the adsorbent magnetic particles. In some embodiments, the particle regeneration apparatus is operable to separate the pollutants from the adsorbent magnetic particles using at least a heat treatment, while in further embodiments the particle regeneration apparatus is operable to separate the pollutants from the adsorbent magnetic particles using at least an aqueous solution.

In one or more embodiments of the system, the particle collector is a bag house, while in further embodiments the particle collector may be an electrostatic precipitator.

In another aspect, the invention provides a particle for use in air pollutant removal that includes a magnetic material and a sorbent material. Embodiments of this particle may further include a binder. In additional embodiments, the sorbent material includes a metal oxide, while in further embodiments the sorbent material includes a manganese oxide. In additional embodiments, the sorbent material includes a metal sulfide, while in further embodiments the sorbent material includes molybdenum disulfide.

In additional embodiments of the particle that includes a magnetic material and a sorbent material, the magnetic material includes iron, while in further embodiments the magnetic material includes magnetite. Embodiments of the particle that include magnetite may further include manganese dioxide and have a nominal diameter of about 100 microns or less.

In additional embodiments of the particle, the magnetic material and the sorbent material include a spinel. In further embodiments, the spinel includes iron (Fe), manganese (Mn), and oxygen (O), wherein the relative molar fractions are expressed by A and B in Fe_{A}Mn_{B}O_{4+C}, and a non-stoichiometric amount of oxygen is expressed by C.

In other embodiments of the particle including a magnetic material and a sorbent material, the particle may have a nominal diameter of about 100 microns or less, while in additional embodiments the particle has a nominal diameter of about 50 microns or less.

Another aspect of the invention provides a method for use in removing pollutants from a gas stream, that includes introducing adsorbent magnetic particles into a gas stream, wherein each of a plurality of the adsorbent magnetic particles include a magnetic material and a sorbent material, wherein the adsorbent magnetic particles associate with pollutants in the gas stream; and removing the adsorbent magnetic particles associated with pollutants from the gas stream. In further embodiments, the adsorbent magnetic particle includes a binder.

In one or more embodiments of this method, the sorbent material includes a metal oxide, while in further embodiments the sorbent material includes a manganese oxide. For these embodiments, the pollutants may be selected from the group consisting of mercury, sulfur oxides, and nitrogen oxides.

In one or more embodiments of this method, the sorbent material includes a metal sulfide, while in further embodiments the sorbent material includes molybdenum disulfide. For these embodiments, the pollutants include at least one of mercury and sulfur oxides. For particles including metal sulfides, in some embodiments the particles may associate with pollutants in the gas stream primarily while the particles are in flight in the gas stream.

Further embodiments of this method can include one or more of the embodiments of particles that include a magnetic material and a sorbent material, as described herein.

In embodiments of the methods that use particles including spinels, the pollutants may be selected from the group consisting of mercury, sulfur oxides, and nitrogen oxides.

In other embodiments, the method further includes removing non-magnetic waste material from the gas stream. Yet further embodiments may include magnetically separating the non-magnetic waste material from the adsorbent magnetic particles associated with pollutants. In some embodiments, the non-magnetic waste material may include fly ash. Additional embodiments may also include regenerating the adsorbent magnetic particles associated with pollutants.

Other embodiments include flowing the gas stream through an adsorbent filter subsequent to removing the adsorbent magnetic particles associated with pollutants from the gas stream.

Another aspect of the invention provides a system for use in removing pollutants from a gas stream that includes a conduit for receiving a gas stream from a gas stream source; a magnetic particle feeder operable to introduce adsorbent magnetic particles into the gas stream, wherein each of a plurality of the adsorbent magnetic particles include a magnetic material and a sorbent material; and a particle collector operable to remove the adsorbent magnetic particles from the gas stream after one or more adsorbent magnetic particles have associated with a pollutant in the gas stream.

In one or more embodiments of the system using particles that include a magnetic material and a sorbent material, the system further includes an exhaust port that guides the gas stream to the atmosphere after it has passed through the particle collector and an adsorbent filter between the particle collector and the exhaust port. In additional embodiments, the adsorbent filter may include a sorbent material-coated honeycomb block filter.

Further embodiments of the system can include one or more of the embodiments of particles that include a magnetic material and a sorbent material, as described herein. For embodiments in which the sorbent material includes a metal sulfide, the adsorbent magnetic particles may associate with pollutants in the gas stream primarily while the particles are in flight in the gas stream.

The gas stream source in embodiments of the system may include an exhaust gas stream from a manufacturing or power plant.

In one or more embodiments of the system, the particle collector is further operable to remove non-magnetic waste material from the gas stream. This non-magnetic waste material may include fly ash.

Embodiments of the system may further include a magnetic separator operably connected to the particle collector, wherein the non-magnetic waste material is separated from adsorbent magnetic particles associated with pollutant by the magnetic separator.

Embodiments of the system may also include a particle regeneration apparatus operable to separate pollutants from the adsorbent magnetic particles. In some embodiments the particle regeneration apparatus is operable to separate the pollutants from the adsorbent magnetic particles using at least a heat treatment. In yet further embodiments the particle regeneration apparatus is operable to separate the pollutants from the adsorbent magnetic particles using at least an aqueous solution.

Embodiments of the system that include use of particles including magnetic material and sorbent material may include one or more bag house particle collectors. In further embodiments, the particle collector may be an electrostatic precipitator.

Another aspect of the invention provides a particle for use in air pollutant removal that includes a magnetic material and an oxidizing agent. In some embodiments, the magnetic material of these particles includes an iron oxide, while in farther embodiments the magnetic material includes magnetite.

In one or more embodiments, the particle has a nominal diameter of about 50 microns or less, while in further embodiments the particle has a nominal diameter of about 25 microns or less.

In additional embodiments, the oxidizing agent includes sodium persulfate, while in further embodiments the oxidizing agent includes sodium iodide. In one or more embodiments, the oxidizing agent is provided as a layer on at least a portion of the magnetic material.

In additional embodiments, the particle has a nominal diameter of about 100 microns or less.

Another aspect of the invention provides a method for use in removing pollutants from a gas stream that includes introducing adsorbent magnetic particles into a gas stream, wherein each of a plurality of the adsorbent magnetic particles include strongly magnetic iron oxide and have a nominal diameter of about 50 microns or less, wherein the adsorbent magnetic particles associate with pollutants in the gas stream; and removing the adsorbent magnetic particles associated with pollutants from the gas stream.

In additional embodiments of the method, the iron oxide includes uncoated magnetite. In further embodiments, the adsorbent magnetic particles may be introduced into a gas stream prior to an existing particle collector.

In additional embodiments of the method for using adsorbent magnetic particles that include strongly magnetic iron oxide, the adsorbent magnetic particles may have a nominal diameter of about 25 microns or less.

In embodiments of the method, the pollutants include oxidized mercury.

In additional embodiments, the method further includes removing non-magnetic waste material from the gas stream. This non-magnetic waste material may include fly ash.

Embodiments of the method may further include magnetically separating the non-magnetic waste material from the adsorbent magnetic particles associated with pollutants. Further embodiments of the method include regenerating the adsorbent magnetic particles associated with pollutants.

Additional embodiments of the method may further include introducing calcium carbonate or calcium hydroxide into the gas stream. For these embodiments, the pollutants may include mercury and sulfur oxides.

One or more embodiments of the method using adsorbent magnetic particles that include strongly magnetic iron oxide further include flowing the gas stream through an adsorbent filter subsequent to removing the adsorbent magnetic particles associated with pollutants from the gas stream.

In a further embodiment of the method of using adsorbent magnetic particles that include strongly magnetic iron oxide and have a nominal diameter of about 50 microns or less, the method includes introducing magnetic oxidizing particles into a gas stream, wherein each of a plurality of the magnetic oxidizing particles include a magnetic material and an oxidizing agent, wherein the magnetic oxidizing particles oxidize elemental mercury in the gas stream to oxidized mercury; and removing the magnetic oxidizing particles from the gas stream.

The magnetic oxidizing particles may include one or more of the embodiments of particles that include a magnetic material and an oxidizing agent, described herein. For these embodiments, the pollutants may include at least one of oxidized mercury and elemental mercury.

In additional embodiments of the method of using adsorbent magnetic particles that include strongly magnetic iron oxide and have a nominal diameter of about 50 microns or less together with magnetic oxidizing particles, removing the magnetic oxidizing particles from the gas stream includes using a dry separation method. Further embodiments of this method include removing non-magnetic waste material from the gas stream.

In additional embodiments of the method of using adsorbent magnetic particles that include strongly magnetic iron oxide and have a nominal diameter of about 50 microns or less together with magnetic oxidizing particles, the method further includes magnetically separating the non-magnetic waste material from the adsorbent magnetic particles and the magnetic oxidizing particles. Yet further embodiments may include regenerating the adsorbent magnetic particles associated with pollutants.

Additional aspects of the invention provide a system for use in removing pollutants from a gas stream that includes a conduit for receiving a gas stream from a gas stream source; a magnetic particle feeder operable to introduce adsorbent magnetic particles into the gas stream, wherein each of a plurality of the adsorbent magnetic particles include a strongly magnetic iron oxide particle with a nominal diameter of about 50 microns or less; and a particle collector operable to remove the adsorbent magnetic particles from the gas stream after one or more adsorbent magnetic particles have associated with a pollutant in the gas stream. In one or more embodiments of this system, the iron oxide includes magnetite.

Additional embodiments of the system may further include an exhaust port that guides the gas stream to the atmosphere after it has passed through the particle collector and an adsorbent filter between the particle collector and the exhaust port. In yet further embodiments, the adsorbent filter includes a sorbent material-coated honeycomb block filter.

In additional embodiments of the system using adsorbent magnetic particles that include strongly magnetic iron oxide and have a nominal diameter of about 50 microns or less, the gas stream source includes an exhaust gas stream from a manufacturing or power plant.

In other embodiments of this system, the system further includes a magnetic particle feeder for introducing magnetic oxidizing particles into a gas stream, wherein each of a plurality of the magnetic oxidizing particles includes a magnetic material and an oxidizing agent, wherein the magnetic oxidizing particles oxidize elemental mercury in the gas stream to oxidized mercury, and wherein the particle collector is operable to remove the magnetic oxidizing particles from the gas stream. The magnetic oxidizing particles may include one or more of the embodiments of particles that include a magnetic material and an oxidizing agent, described herein.

In further embodiments of the system, the particle collector is further operable to remove non-magnetic waste material from the gas stream.

In additional embodiments for the system using adsorbent magnetic particles that include strongly magnetic iron oxide and have a nominal diameter of about 50 microns or less and magnetic oxidizing particles, a particle regeneration apparatus operable to separate pollutants from the adsorbent magnetic particles may be included. The non-magnetic waste material may include fly ash.

In additional embodiments, the system including use of adsorbent magnetic particles that include strongly magnetic iron oxide and have a nominal diameter of about 50 microns or less and magnetic oxidizing particles, the system further includes a magnetic separator operably connected to the particle collector, wherein the non-magnetic waste material is separated from adsorbent magnetic particles associated with pollutant by the magnetic separator. Additional embodiments of this system may include a particle regeneration apparatus operable to separate pollutants from the adsorbent magnetic particles. In further embodiments of this system, the particle regeneration apparatus may be operable to separate the pollutants from the adsorbent magnetic particles using at least a heat treatment.

In additional embodiments of the system, the particle collector is a bag house, while in further embodiments the particle collector is an electrostatic precipitator.

The present invention provides particles (e.g., adsorbent magnetic particles), systems, and methods for use in removing pollutants from a gas stream, as well as methods for providing such particles.

Unless otherwise specified, “a,” “an,” “the,” and “at least one” are used interchangeably and mean one or more than one.

### BRIEF DESCRIPTION OF THE FIGURES

The following figures illustrate various aspects of one or more embodiments of the present invention, but are not intended to limit the present invention to the embodiments shown.

FIG. 1 provides a diagrammatic cross-section view of a layered adsorbent magnetic particle.

FIG. 2 provides a greatly magnified image of the surface of an adsorbent magnetic particle illustrating the high-surface area nature of the sorbent layer of a particle such as that illustrated in FIG. 1.

FIG. 3 illustrates a perspective view of an approximately one-half inch long portion of foamed iron oxide for use in providing foamed particles.

FIG. 4 provides a schematic block diagram of one exemplary embodiment of a system for air pollutant removal using adsorbent magnetic particles.

FIG. 5 provides a schematic block diagram of one exemplary embodiment of a system for air pollutant removal using adsorbent magnetic particles and an optional adsorbent filter.

FIG. 6 provides a schematic block diagram of one exemplary embodiment of a system for waste particle separation, disposal, and regeneration for use with the system shown in FIG. 4 and FIG. 5.

FIG. 7 provides a schematic block diagram of one exemplary embodiment of a system for chemically regenerating MnO₂ adsorbent.

### DETAILED DESCRIPTION OF THE INVENTION

To illustrate the invention, several embodiments of the invention will now be described in more detail. Reference will be made to the drawings, which are summarized above. Reference numerals will be used to indicate parts and locations in the drawings. The same reference numerals will be used to indicate the same parts or locations throughout the drawing unless otherwise indicated.

### Adsorbent Magnetic Particles

One or more embodiments of the present invention provide adsorbent magnetic particles that may be used for air pollutant removal. The adsorbent magnetic particles have the capacity to adsorb pollutants from the gas stream, and are magnetic to facilitate handling. One or more embodiments of the invention also provide a system and method for using the adsorbent magnetic particles in which the particles are introduced into a gas stream, adsorb pollutants, and are then removed for disposal or magnetic separation, and also, optionally, regeneration and reuse. One or more embodiments of the invention provide the advantage of readily utilizing existing particulate control systems with minimal modification.

The adsorbent magnetic particles may have one or more of the following characteristics, including, but not limited to the capacity to generate a magnetic field and the ability to capture air pollutants. In one or more embodiments, the layered adsorbent magnetic particles provide a surface area of 25 m²/g or more. In further embodiments, the particles also have a relatively high surface area, a high pollutant loading capacity, low reactivity with non-pollutants, a capacity for regeneration, a size appropriate for capture by existing particle removal systems, and/or can be cost-effectively manufactured from inexpensive starting materials.

Adsorbent magnetic particles may also generally be small enough to become airborne when placed within a gas stream. Accordingly, adsorbent magnetic particles of the invention generally have a nominal diameter of about 100 microns or less. In additional embodiments of the invention, smaller particles may be used. For example, further embodiments of the invention may include adsorbent magnetic particles with a nominal diameter of about 75 microns or less, 50 microns or less, or 25 microns or less. A nominal diameter, as used herein, refers to a designated diameter that is used to categorize the particles, and is generally determined by evaluating the ability of the particles to pass through a mesh of a specified size. However, while the majority of particles of a particular nominal diameter will have sizes less than or equal to the specified size, a batch of particles with a specified nominal diameter may include a small number of particles that exceed the specified size.

Different embodiments of the invention are useful for removing different types of pollutants that may be present in a gas stream. For example, some embodiments of the invention remove mercury from the gas stream. The mercury removed may be in the oxidized form or the elemental form, or both forms of mercury may be removed. Examples of embodiments that may be used to remove mercury from a gas stream include finely ground iron oxide particles (i.e., iron oxide particles with a nominal diameter of about 50 microns or less) and finely ground iron oxide particles that are supplemented by magnetic oxidizing particles.

In further embodiments of the invention, sulfur oxides are removed along with mercury from a gas stream. For example, mercury and sulfur oxides may be removed from the gas stream using adsorbent magnetic particles that include metal sulfides. Mercury and sulfur oxides may also be removed from the gas stream by supplementing injection of the adsorbent magnetic particles in the gas stream with injection of calcium carbonate. Alternately, the calcium carbonate may be provided as part of the adsorbent magnetic particles themselves. One example of particles including calcium carbonate is foamed iron oxide particles.

In yet further embodiments of the invention, mercury, sulfur oxides, and nitrogen oxides may be removed by the adsorbent magnetic particles of the invention. To remove all three of these pollutants, particles generally are provided with more than one type of material. For example, particles may be provided in which two or more differing materials are included in a mixture, or composite, within the particle. These differing materials generally include at least one magnetic material and at least one sorbent material. These differing materials may also be provided by forming the particle from a spinel, which are minerals that combine certain materials in specific ratios.

In an additional embodiment, the differing materials may be provided as layers. For example, adsorbent magnetic particles may include a sorbent layer that is provided on at least a portion of a magnetic core. These various types of adsorbent magnetic particles, as well as others, are further described herein.

### Magnetic Materials

Various metals and metal oxides may be suitable for use in one or more embodiments of adsorbent magnetic particles. While various combinations of metals and metal oxides can be used, in one or more embodiments of the invention, a significant portion (i.e., at least 50%) of the particle is a magnetic metal or magnetic metal oxide, which are referred to herein as magnetic materials. Generally, the magnetic metal or magnetic metal oxide includes ferrous material such as iron or an iron oxide. For example, one magnetic metal oxide that may be used is magnetite (Fe₃O₄). Magnetite is well suited for use in magnetic particles, as it strongly magnetic, inexpensive, and readily available (e.g., from taconite plants). Magnetite may also be mixed with other iron oxides. For example, maghemite (a mixture of Fe₃O₄ and Fe₂O₃) may also be used.

The magnetic materials used in one or more embodiments of adsorbent magnetic particles of the invention generally have relatively strong magnetic properties. These magnetic properties should be sufficient to allow the particles to be readily separated from other materials as a result of their magnetism. For example, the magnetic properties of adsorbent magnetic particles of the invention may be used to aid in separating the particles from other waste materials (e.g., fly ash) found in a gas stream (e.g., the gas stream of a power plant). While embodiments of the invention may use materials which are merely magnetically susceptible (e.g., paramagnetic materials), the magnetic materials used in adsorbent magnetic particles of the invention are generally magnetic, as opposed to paramagnetic.

Magnetic susceptibility of materials is generally measured using the centimeters-grams-second (CGS) system, where force is measured in dynes. A dyne is the force required to accelerate a mass of one gram at one centimeter per second squared. Strongly magnetic materials, as defined herein, have a magnetic susceptibility of 5,000×10⁻⁶ c.g.s. units or more. Some embodiments of the invention may use magnetic materials with a magnetic susceptibility of 7,000×10⁻⁶ c.g.s. or more. For reference, magnetite has a magnetic susceptibility of 7,200×10⁻⁶ c.g.s. units, hematite has a magnetic susceptibility of 3,586×10⁻⁶ c.g.s. units, Manganese has a magnetic susceptibility of 483 to 529×10⁻⁶ c.g.s. units, depending on its form, and molybdenum oxide has a magnetic susceptibility of 41×10⁻⁶ c.g.s. units. A chart describing the magnetic properties and susceptibilities of various materials is provided by the Reade Advanced Materials Supersite on the world wide web, and is incorporated herein by reference.

As is known by those skilled in the art, magnetic fields and magnetic material properties arise from the motion of electrons. In materials that exhibit bulk magnetic properties, electron orbitals nearer the nucleus are not evenly filled, so those electrons are not completely paired and through an interaction between adjacent atomic dipoles, a coupling occurs that tends to align the orbits of the electrons involved. In this manner, alignment of great numbers of atomic dipoles in a material will produce bulk magnetism. Magnetite has strong magnetic properties because it is composed of iron atoms in two different states, with one atom with a valence of +2 and two atoms with a valence of +3. A valence number is usually the number of outer electrons, which are those in the outermost and highest energy band. In magnetite, the magnetic dipoles of the two Fe³⁺ atoms are pointed oppositely and cancel each other. However, the magnetic dipole of the Fe²⁺ atom tends to align with many adjacent dipoles of other Fe²⁺ atoms throughout the mineral. The alignment of numerous atomic dipoles within a material results in a magnetic material that produces a significant magnetic field.

Materials that have good adsorbent properties but do not have a sufficiently high level of magnetic strength may be converted to a more magnetic form for use in adsorbent magnetic particles. For example, manganiferous iron ore obtained from the Cuyuna iron range in east-central Minnesota includes mainly limonite (Fe₂O₃.H₂O), iron carbonate, manganite (Mn₂O₂.H₂O) and pyrolusite (MnO₂), and is relatively non-magnetic. Magnetized roasting may be used to convert the iron oxides and carbonates of materials of this sort into magnetic magnetite. While such magnetized roasting may have the effect of converting the manganese compounds present to MnO, which is a relatively poor adsorbent, this can be corrected by oxidation to MnO₂ while retaining a strong magnetic character.

Sorbent Materials

In one more embodiments, the magnetic materials used in adsorbent magnetic particles adsorb pollutants from the gas stream in addition to providing magnetic properties. However, additional materials may be provided for the adsorbent magnetic particles in some embodiments of the invention to increase the affinity for pollutants or expand the number of pollutants adsorbed by the particles. These additional materials are referred to herein as sorbent materials. For example, various metal oxides, such as oxides of manganese, magnesium, calcium, silicon, titanium, scandium, chromium, nickel, copper, zinc, aluminum, yttrium, rhodium, palladium, silver, cadmium, titanium, cobalt, and combinations thereof, may be used as sorbent materials. In particular, embodiments of the invention may use manganese oxides as a sorbent material, as manganese oxides are an effective adsorbent for mercury. There are numerous forms of manganese oxide, including, for example, Mn₂O₃, Mn₃O₄, and MnO₂.

Other materials may also be used as sorbent materials. For example, metals may be used as sorbent materials in adsorbent magnetic particles. Metals may be, for example, iron, gold, silver, copper, and alloys thereof.

Another group of materials that may be used as sorbent materials are metal sulfides. Examples of metal sulfides include tungsten disulfide, lead sulfide, zinc sulfide, copper sulfide, manganese sulfide, nickel sulfide, iron sulfide, and molybdenum disulfide. For example, a metal sulfide that may be used as a sorbent material for adsorbent magnetic particles is molybdenum disulfide. Selection of suitable metals, metal oxides, and/or metal sulfides can be tailored to provide magnetic particles that are ideal for removal of the desired target pollutants and process conditions.

### Composite Adsorbent Magnetic Particles

One or more embodiments of the invention may include composite adsorbent magnetic particles that include a plurality of differing materials. A composite, as defined herein, is a mixture of a plurality of materials (e.g., metals, metal oxides, and metal sulfides). Generally, but not necessarily, the materials in a composite adsorbent magnetic particle are mixed in an irregular fashion such that the materials are dispersed and found in various portions of the particles. As previously noted, use of differing materials in adsorbent magnetic particles, such as use of a magnetic material and a sorbent material, can be advantageous. For example, differing materials often have different capacities for capturing and retaining various air pollutants, so that the use of multiple materials may result in a greater range and/or capacity to remove pollutants from a gas stream.

One example of how different materials may be combined in an adsorbent magnetic particle is the formation of a composite between a metal and a metal oxide. Such a composite could be formed from magnetic material such as magnetite to provide the particle with magnetism and the ability to capture oxidized mercury, combined with a metal such as copper to provide an enhanced ability to capture elemental mercury. Alternately, magnetite could be combined with another metal oxide such as manganese dioxide to provide a magnetic particle that has the ability to remove both elemental and oxidized mercury, as well as other pollutants such as SO_{X} and NO_{X}. Magnetite may also be combined with a metal sulfide such as molybdenum disulfide (MoS₂) to provide an adsorbent magnetic particle that includes differing materials.

In addition to providing the capacity to remove additional airborne pollutants, inclusion of differing materials may also lead to more rapid rates of pollutant removal. For example, inclusion of molybdenum disulfide may provide particles that are able to rapidly remove airborne pollutants while traveling through the gas stream.

Ores already containing differing materials, such as the manganiferous iron ore described earlier, provide a ready source of material for use in providing composite adsorbent magnetic particles.

The differing materials present in a composite particle may be held together in a variety of ways. In some embodiments, the materials may have sufficient affinity for one another to form a cohesive particle when mixed together. Alternately, a binder may be supplied to help the differing materials adhere together to form a cohesive particle. Examples of binders include phosphoric acid or a colloidal silica such as sodium silicate.

Composite adsorbent magnetic particles can be provided in a variety of ways. For example, the two materials may be physically or chemically mixed to form an aggregate which is then pulverized to form particles of suitable sizes.

In other embodiments, adsorbent magnetic particles may be prepared by spray drying. Adsorbent magnetic particles prepared by spray drying generally have a fairly even, dispersed mixture of sorbent and magnetic material. Spray drying involves the atomization of one or more liquid feedstocks into a spray of droplets and contacting the droplets with hot air in a drying chamber. The drying chamber may be a separate chamber, or part of the conduit conducting the gas stream. The sprays may be produced, for example, by either rotary wheel or nozzle atomizers. Evaporation of moisture from the droplets and formation of dry particles may be conducted under controlled temperature and airflow conditions. Spray drying equipment can be obtained commercially from companies such as Niro Inc. (Columbia, Md.). Spray drying may also be used to prepare additional types of magnetic particles described herein, such as foamed iron oxide particles.

Another example of composite adsorbent magnetic particles includes adsorbent magnetic particles that include spinels. Spinels are metal oxide minerals that contain a variety of elements in a defined formula. The general formula of a spinel is DT₂O₄, in which D represents a divalent metal ion such as magnesium, iron, nickel, manganese and/or zinc, and T represents trivalent metal ions such as aluminum, iron, chromium and/or manganese. Examples of spinels include magnetite, chromite, and franklinite. In one embodiment, iron-manganese spinels produced with an excess of oxygen atoms in their crystal lattice are used, as they are capable of removing at least 50% and up to 99% of the combined elemental and oxidized mercury from a flue gas stream and are sufficiently magnetic to be magnetically separated from flue gas and fly ash. Iron-manganese spinels have a formula of Fe_{A}Mn_{B}O_{4+c}, where A and B are relative molar fractions and C is the amount of excess (i.e., non-stoichiometric) oxygen in the crystal lattice. The structure of highly divided nonstoichiometric iron manganese oxides is described by Fritsch et al., “Structure of Highly Divided Nonstoichiometric Iron Manganese Oxide Powders Fe₃₋ₓMn_{X}□3_{δ/4}O_{4+δ}”, J. Solid State Chem., 146, 245-252 (1999).

### Layered Adsorbent Magnetic Particles

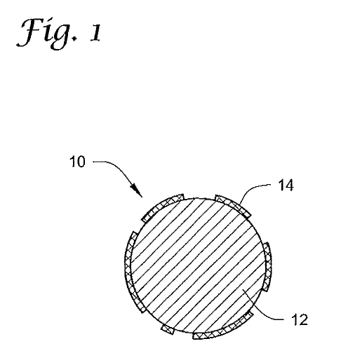

In a further embodiment of the invention, adsorbent magnetic particles are provided in which one material is layered over at least a portion of another material. This is another approach to providing an adsorbent magnetic particle that includes differing materials. For example, a layered adsorbent magnetic particle may provide a sorbent material layer over at least a portion of a magnetic core, where the magnetic core is a particle formed at least in part from magnetic material. A cross-sectional view showing an example of a layered adsorbent magnetic particle 10 is provided in FIG. 1. FIG. 1 shows a layered adsorbent magnetic particle 10 in which a sorbent layer 14 is provided over at least a portion of a magnetic core 12 of the particle 10.

The magnetic core 12 includes a magnetic material that provides an effective method of separating the adsorbent magnetic particles 10 from non-magnetic material. The material used to form the magnetic core 12 may also generally have the capacity to adsorb pollutants. While the magnetic core 12 is generally roughly spherical, the shape of the magnetic core 12 can vary substantially. The material used to form the magnetic core 12 can come from a variety of sources. An example of a magnetic material that may be used to form the magnetic core 12 in these particles is acid washed natural magnetite. Another magnetic material that may be used to form a magnetic core 12 is chemical formed, pure, high-surface area magnetite particles. The magnetic core 12 may be chemically formed, for example, through oxidation of iron from Fe⁺² to Fe⁺³ in solution to precipitate small particles. Alternately, finely ground sponge iron particles may be used as magnetic cores 12.

The sorbent layer 14 is provided on the surface of the magnetic core 12 of the adsorbent magnetic particle 10. The sorbent layer 14 may cover the entire surface of the adsorbent magnetic particle, or it may cover only a portion of the surface (e.g., a discontinuous layer formed in contact with the magnetic core 12), as shown in FIG. 1. In one or more embodiments, about 50% to 75% of the surface of the magnetic core is covered with the sorbent layer. In one or more further embodiments, about 75% to 95% of the surface of the magnetic core is covered with the sorbent layer.

The sorbent layer 14 includes a sorbent material that increases the amount or types of air pollutants that can be removed from a gas stream by adsorbent magnetic particles 10. The sorbent layer 14 generally does not significantly interfere with the magnetism provided by the magnetic core 12. Any material that can adsorb air pollutants may be used as a sorbent material for the sorbent layer 14.

Materials that may be used in the sorbent layer 14 include, for example, metals, metal oxides, and metal sulfides. Examples of metal oxides that may be used in the sorbent layer 14 include manganese oxides such as Mn₂O₃, Mn₃O₄, and MnO₂, while an example of a metal sulfide is molybdenum disulfide.

In particular embodiments of the invention, manganese dioxide (MnO₂) is used. Manganese dioxide exists in several forms, including a beta or a gamma form. The gamma form of manganese dioxide in particular is a highly effective sorbent.

A single layer may be used to form the sorbent layer 14, or multiple layers of material may be applied. Each of the one or more layers may include one or more materials, and the composition of layers may differ from one another. Layers of sorbent material may also be doped with other catalyst materials such as TiO₂, platinum, or gold, to provide sorbent layers with increased effectiveness for removing air pollutants.

The sorbent layer 14 may be applied to the magnetic core 12 using a variety of methods. Generally, the sorbent layer 14 is relatively thin compared to the magnetic core 12, as thick sorbent layers require more sorbent material yet typically provide little additional surface area for adsorption of air pollutants than a thin layer provides unless they are highly textured. The reactivity of adsorbent magnetic particles 10 and their capacity to carry pollutants (their loading capacity) is often correlated to the surface area. As high reactivity and loading capacity are both desirable for sorbents, particles with a high surface area are used in a number of embodiments of the invention.

There are a variety of methods of preparing layered particles for use in air pollution. Metal or metal oxide sorbent coatings may be applied by methods such as electrolysis plating, fluidized bed electrolysis, sol-gel thin layer deposition, or chemical deposition. For example, magnetic cores may be combined in an aqueous solution with at least one metal oxide or metal sulfide to at least partially coat the magnetic cores, after which the layered particles are removed from the aqueous solution. Layered adsorbent magnetic particles may also be formed by chemically bonding material onto the magnetic core. Bonding of the layers to the magnetic core may involve the use of binders. Binders may be, for example, phosphoric acid or a colloidal silica such as sodium silicate. An example describing the use of a binder is provided in Example 3 below.

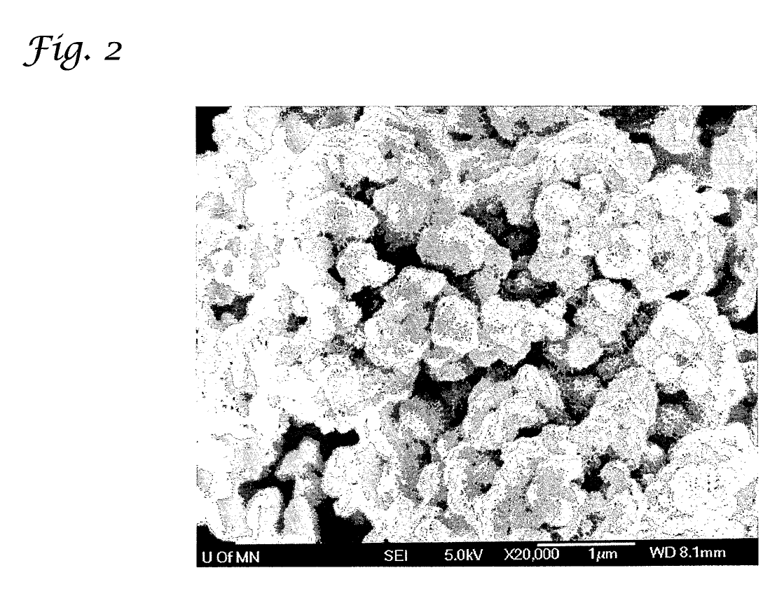

The adsorbent magnetic particles of the invention may also include a nanostructured thin sorbent layer 14. An exemplary texture of a nanostructured thin sorbent layer 14 is shown in FIG. 2, which provides a scanning electron microscope image of a nanostructured thin sorbent layer of manganese dioxide over a magnetite magnetic core 12. As can be seen in FIG. 2, a nanostructured thin sorbent layer 14 has a diverse and complex topography, creating a very high surface area that provides layered adsorbent magnetic particles with optimal reactivity and loading capacity. A nanostructured thin sorbent layer 14 may be created over a magnetic core 12 using various nanotechnological methods. For example, metal oxide materials may be chemically precipitated onto magnetic cores. Nanostructured metal oxide powders may also be chemically bonded to magnetic core particles.

One or more embodiments of the invention include adsorbent magnetic particles that have a high surface area. Surface area is typically described in terms of square meters per gram of material, and is measured using a gas adsorption technique known as the BET (Brunauer-Emmett-Teller) method. The particles of the present invention generally have a surface area ranging from about 1 to about 1000 m²/g. The term “high surface area”, as used herein, refers to a material with a surface area of 100 m²/g or more.

Fabrication of adsorbent magnetic particles including a nanostructured thin sorbent layer 14 and a prepared magnetic core 12 represents a combination of both top-down and bottom-up nanotechnology. The magnetic core 12 is prepared in top-down fashion by, for example, grinding and washing core material to an appropriate particle size. Precipitation of molecules of adsorbent onto the surface of the magnetic core 12 to form a thin sorbent layer 14 is an example of bottom-up nanotechnology, as the individual molecules are combined to form a nanostructured surface layer.

### Fine Adsorbent Magnetic Particles

One or more embodiments of the invention provide fine adsorbent magnetic particles (e.g., finely ground particles) that may be used to remove pollutants. Fine adsorbent magnetic particles, as defined herein, are adsorbent magnetic particles that have a nominal diameter of about 50 microns or less. However, in additional embodiments, fine adsorbent magnetic particles may have a size of 25 microns or less, or 10 microns or less.

Fine adsorbent magnetic particles may be formed of magnetic metals (e.g., iron) and magnetic metal oxides. In one embodiment, the magnetic metals and magnetic metal oxides used to form fine adsorbent magnetic particles are uncoated (i.e., not coated with other materials). In one embodiment, the fine adsorbent magnetic particles are formed primarily of magnetite. Alternately, additional materials may be mixed with the magnetite. For example, in one embodiment, the adsorbent magnetic particles are formed from maghemite.

Small particle size is particularly important when using fine adsorbent magnetic particles formed from magnetic metal oxides such as magnetite, as these materials typically have a relatively smooth surface and thus provide less surface area than other materials that have a rougher surface. Small particle size provides a proportionally greater surface area for a given mass of material. By providing a greater surface area, smaller amounts of adsorbent magnetic particles can be used, which avoids oversaturation of particle collectors in a pollution control system and generally reduces operating costs.

Fine adsorbent magnetic particles formed from metals and metal oxides are well suited for embodiments of the invention directed to removing mercury. In particular, fine adsorbent magnetic particles adsorb oxidized forms of mercury. Fine adsorbent magnetic particles are thus well-suited for use in air pollutant removal systems in which removal of oxidized forms of mercury is the primary objective. For example, mercury produced by coal burning power plants in the eastern United States is primarily in the oxidized form, and thus the mercury provided by these types of facilities could be readily removed by fine adsorbent magnetic particles. Another example of air pollutant sources that form primarily oxidized mercury are air pollutant sources in which salts such as sodium chloride are added to the coal prior to burning or injected above the boiler flame. Salts provided at this point in coal burning cause much of the mercury sent to the gas stream to be in the oxidized form.

In one or more additional embodiments using fine adsorbent magnetic particles, oxidizing agents may be supplied to the gas stream to convert elemental mercury present in the gas stream to oxidized mercury that is more readily adsorbed by the fine adsorbent magnetic particles. Examples of oxidizing agents include permanganate, sodium iodide, and persulfate salts such as sodium persulfate.

The oxidizing agents may be introduced into the gas stream using a variety of different types of particle injectors. For example, the oxidizing agents may simply be introduced into the gas stream by a feeder/rotary valve injector or a pump injecting into a diffuser pipe located in the air stream. Alternately, the fine adsorbent magnetic particles may be provided with a partial coating of oxidizing agent (e.g., the particle is partially coated with the oxidizing agent).

In another embodiment, the oxidizing agent may be supplied as magnetic oxidizing particles. Magnetic oxidizing particles are particles that include a magnetic core, as described herein for layered magnetic adsorbent particles, that is at least partially covered by a layer of oxidizing agent. Use of magnetic oxidizing particles provide several advantages. For example, providing the oxidizing agent with a magnetic core allows the magnetic oxidizing particles to be removed from other waste materials. Providing separate oxidizing particles also avoids the potential problem of obscuring the pollutant removal surface of an adsorbent magnetic particle that may occur if an excess of oxidizing agent is provided on the surface. The oxidizing magnetic particles generally have a nominal diameter of about 100 microns or less.

Magnetic oxidizing particles may be prepared by providing a layer of oxidizing agent over a fine adsorbent magnetic particle (e.g., magnetite particles with a diameter of 50 microns or less) by linking the oxidizing agents to the magnetic particles using reagents such as oleic acid, or by attaching them to the magnetic particles using chemical binders such as phosphate binders. Alternately, the oxidizing agents may simply be dried onto the surface of the adsorbent magnetic particles.

The magnetic oxidizing particles may be introduced into the gas stream along with the fine adsorbent magnetic particles (e.g., uncoated magnetite particles) in various ratios (e.g., based on the level of elemental mercury present in the gas stream). For example, a 50/50 ratio of oxidizing magnetic particles to fine adsorbent magnetic particles (e.g., uncoated magnetite particles) may be used.

Further embodiments of the invention may also include the addition of other materials into the gas stream to supplement pollutant removal by fine adsorbent magnetic particles. For example, calcium carbonate (limestone) may be introduced into the gas stream to improve the removal of sulfur oxides. Addition of calcium carbonate to a gas stream containing sulfur oxides results in the formation of gypsum, which may be readily removed as a non-magnetic waste material.

### Foamed Adsorbent Magnetic Particles

Another embodiment of the invention provides adsorbent magnetic particles that include a foamed magnetic material. A foamed material is a material that includes a plurality of voids defined by the bulk of the material (e.g., such voids formed during a foaming process). Foamed adsorbent magnetic particles generally have a nominal diameter of about 100 microns or less. Use of a foamed magnetic material provides adsorbent magnetic particles that are lightweight and have a high surface area, while still providing magnetic and pollutant adsorbing properties.

Foamed magnetic particles generally use the same materials that may be used in other types of adsorbent magnetic particles as described herein, but rather than having a solid structure they include a large number of voids (e.g., pores and channels). These pores and/or channels increase the overall surface area of the structure, as well as reducing the weight of the structure.

Foamed adsorbent magnetic particles may have a weight that is significantly less than that of non-porous adsorbent magnetic particles. For example, porous adsorbent magnetic particles may have a weight that is 75% or less than that of equivalent non-porous adsorbent particles. In additional embodiments, foamed adsorbent magnetic particles may have a weight that is 50% or less than that of equivalent non-porous adsorbent magnetic particles.

Foamed adsorbent magnetic materials may include a single material, or they may combine a plurality of differing materials. For example, one or more embodiments of foamed magnetic particles may include a foamed iron oxide. Additional embodiments of foamed adsorbent magnetic materials may include magnetite. Sorbent materials such as metal oxides or metal sulfides may also be included, with particular examples being the inclusion of molybdenum disulfide and/or manganese dioxide.

Foamed adsorbent magnetic particles can be prepared in a variety of ways. For example, foamed adsorbent magnetic particles can be prepared from adsorbent magnetic particles containing a differing material that is subsequently leached away, leaving voids (e.g., pores and channels). One example of this process may include magnetic particles formed from a mixture of magnetite and silica, where the silica is subsequently removed by exposure to acid, leaving magnetite particles that include voids (e.g., pores and/or channels).

Alternately, the adsorbent magnetic particles can be formed by foaming a material using a foaming agent, resulting in the formation of voids (e.g., pores and/or channels) in the magnetic material. Foaming agents may include, for example, a variety of agents that react with acid to release a gas (e.g., carbon dioxide), such as carbonates (e.g., Na₂CO₃ or CaCO₃), Ca(OH)₂, or CaO. For example, foamed magnetic particles can be prepared by combining iron oxide with calcium carbonate and then exposing the mixture to an acid such as phosphoric acid. In this aspect of the invention, the acid (e.g., phosphoric acid) reacts with the calcium carbonate to release carbon dioxide that bubbles through the magnetic material to form voids (e.g., pores and channels). One advantage to the use of phosphoric acid is that it simultaneously reacts with the iron oxide to form iron phosphates, which reinforce and maintain the structure of the foamed iron oxide.

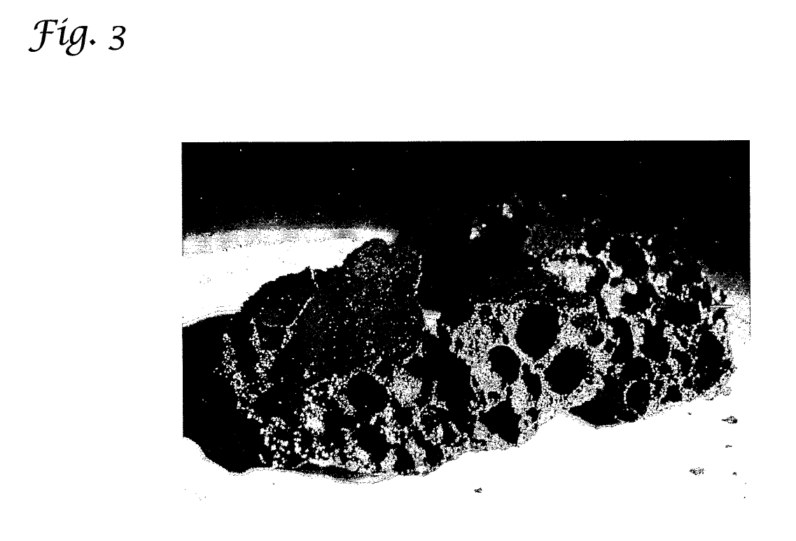

A portion of foamed iron oxide of approximately one half inch in size is shown in FIG. 3, which illustrates the high degree of void formation that may be present in a foamed iron oxide. This foamed material can be easily ground or otherwise mechanically disrupted to form light-weight particles that retains numerous voids (e.g., pores and channels). Foamed particles formed in this fashion have been shown to have a weight that is half that of solid adsorbent magnetic particles, which demonstrates the retention of pores and channels even after grinding to a small particle size. Thus, taken as a whole, this method involves, in at least one embodiment, using phosphoric acid and calcium carbonate to foam an iron oxide, wherein the foamed iron oxide includes iron phosphate, and then forming the foamed iron oxide into foamed particles.

Foamed adsorbent magnetic particles can also be formed by spray drying. For example, in such a process, the foaming of the iron oxide and the formation of the particles generally occurs simultaneously. For example, foamed iron oxide particles can be formed by spraying together a stream of iron oxide particles in phosphoric acid solution and a stream of calcium carbonate in aqueous solution.

In some embodiments of foamed adsorbent magnetic particles, the calcium carbonate is not completely used up during foaming of the material, but rather portions of un-reacted calcium carbonate remain that are dispersed throughout the particle after foaming. This provides the foamed adsorbent magnetic particles with an enhanced ability to remove sulfur oxides from a gas stream. For example, foamed adsorbent magnetic particles formed from iron oxide and calcium carbonate where portions of the calcium carbonate remain un-reacted will have the ability to remove both mercury and sulfur oxides from a gas stream.

### Pollutant Removal and Regeneration of Adsorbent Magnetic Particles

The adsorbent magnetic particles 10 of the present invention are capable of removing a wide variety of air pollutants. Removal of a pollutant from the gas stream refers to removal of 50% or more of the pollutant. However, additional embodiments of the invention may provide for higher levels of removal, such as 75%, 90%, or 95% removal.

Air pollutants are defined for the present invention as including all criteria pollutants and hazardous air pollutants listed by the Environmental Protection Agency. As noted earlier, criteria pollutants include carbon monoxide, lead, nitrogen oxides (NO_{X}), ozone, particulate matter, and sulfur oxides (SO_{X}). Examples of criteria pollutants removed by adsorbent magnetic particles of the invention include nitrogen dioxides and sulfur dioxides. Hazardous air pollutants include numerous compounds and are provided by the Environmental Protection Agency (EPA), Office of Air Quality, Planning & Standards, in section 112: Hazardous Air Pollutants List. Examples of hazardous air pollutants that may be removed by the adsorbent magnetic particles of the invention include mercury and mercury compounds. In various embodiments, removal of oxidized and/or elemental mercury may be particularly effective.

Mercury adsorption is fairly complex, primarily due to the fact that mercury speciation leads to the formation of a wide variety of mercury compounds that are adsorbed differently. Such mercury species include HgCl₂, HgO, HgSO₄, HgS, as well as several other less stable compounds, with HgCl₂ being the predominant species.

While not intending to be bound by theory, some aspects of mercury adsorption are understood and help explain the removal of mercury by sorbents used in the present invention. Oxidized forms of mercury such as HgCl₂ are fairly readily adsorbed by metal oxides such as magnetite. Metal oxides may catalyze the oxidation of elemental mercury in flue gases. The reaction mechanism for the capture of mercury by oxide catalysts is believed to proceed as follows:

Hg_{(gas)}+particle→Hg_{(adsorbed)}

Hg_{(adsorbed)}+M_{X}O_{Y}→HgO(adsorbed)+M_{X}O_{Y-1}

HgO_{(adsorbed)}+M_{X}O_{Y-1}+1/2O₂(gas)→HgO_{(adsorbed)}+M_{X}O_{Y}

Hg_{(adsorbed)}+M_{X}O_{Y}→HgM_{X}O_{Y+1}

M in the reactions above represents a metal that is part of a metal oxide, where the stoichiometric ratio of the metal to oxygen is represented by X and Y, respectively.

Elemental mercury generally has a high affinity for metals such as copper and gold, but has an even higher affinity for manganese dioxide. Thus, combinations of materials such as the combination of manganese dioxide and magnetite provide the capacity to remove both oxidized and elemental forms of mercury. The reaction pathways and adsorption of mercury and mercury compounds on sorbents are further discussed by Pavlish et al., Fuel Processing Technology, 82, 89-165 (2003).

In a further embodiment of the invention, removal of elemental mercury can be improved by addition of oxidizing agent. The presence of an oxidizing agent converts elemental mercury to oxidized mercury that can be more readily removed by some embodiments of the adsorbent magnetic particles of the invention. The oxidizing agent may be incorporated into the adsorbent magnetic particles, or it may be provided on separate magnetic oxidizing agent particles. The oxidizing agent may also be included freely, without being bound to a magnetic particle. However, this may make recovery and regeneration of the oxidizing agent more difficult. Examples of oxidizing agents include sodium persulfate and sodium iodide.

Embodiments of the adsorbent magnetic particles of the invention may also adsorb the criteria air pollutants nitrogen oxides (NO_{X}) and sulfur oxides (SO_{X}). For example, the reactions that are believed to occur between the sorbent manganese dioxide and these two criteria air pollutants are shown below:

MnO_{2(solid)}+SO_{2(gas)}→MnSO_{4(solid)}

MnO_{2(solid)}+2NO_{(gas)}→Mn(NO₃)_{2(solid)}

Manganese dioxide is used in the above reactions as an example sorbent only, as a wide variety of other sorbents may be used in the present invention. The reactions between pollutants and sorbents may include multiple steps. While sorbents may capture air pollutants through chemical reaction between the sorbent and the pollutant, other types of interaction between the sorbent and pollutants may enable the capture of pollutants as well.

Adsorbent magnetic particles of the invention may also have the capacity to be regenerated for reuse. As described herein, pollutants adsorb to the magnetic materials and sorbent materials used to form adsorbent magnetic particles. As pollutants adsorb to the adsorbent magnetic particles, reaction sites are gradually occupied and the adsorbent magnetic particles ability to adsorb further pollutants is gradually decreased. In order to prevent the particles from gradually losing their ability to adsorb pollutants, the particles should be regenerated or replaced with fresh adsorbent magnetic particles.

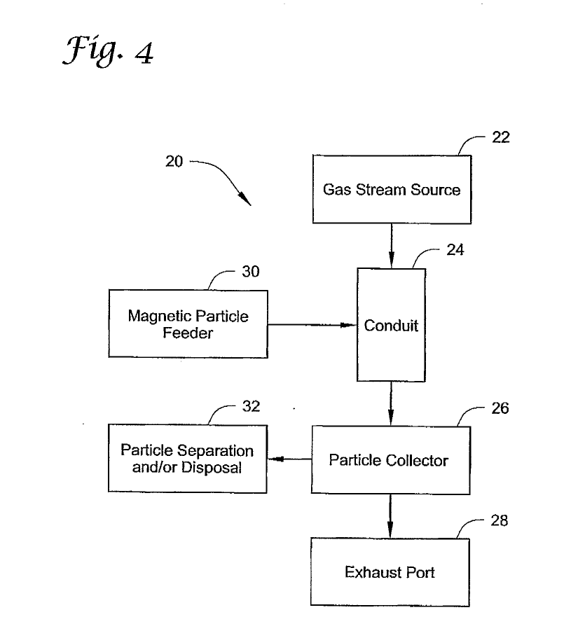

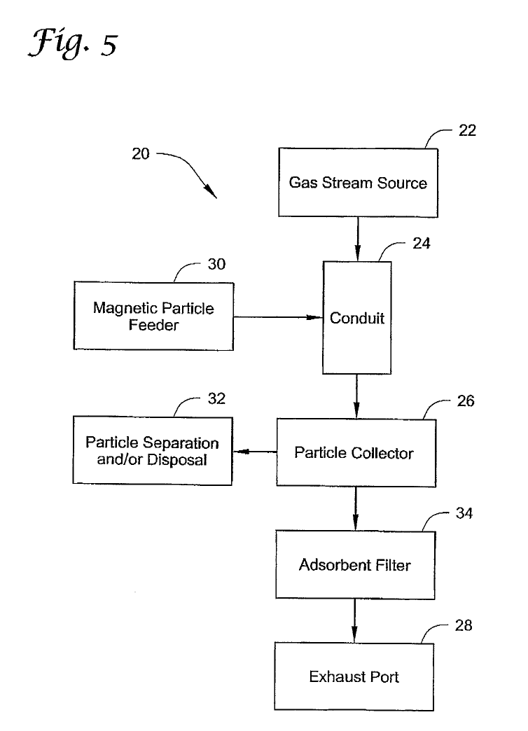

To regenerate adsorbent magnetic particles, the adsorbed pollutants are generally removed from the particles to increase their capacity to adsorb pollutants. Air pollutant removal systems of the invention may include steps for recycling and reusing the adsorbent, as shown in FIG. 4 and FIG. 5. Adsorbent magnetic particles may be regenerated by direct removal of pollutants from the adsorbent magnetic particles. For example, fine adsorbent magnetic particles may be heated to stimulate the release of bound mercury. Alternately, or in addition, adsorbent magnetic particles may be regenerated using an aqueous solution. When using an aqueous solution, regeneration is generally accomplished by removing the sorbent material, chemically treating it, and then reapplying the sorbent material to form a new sorbent layer. Regeneration may be accomplished through various methods, such as degassing under reduced pressure, thermal decomposition, or chemical reactivation. In one embodiment, regeneration of the particles includes washing the used sorbent in water to solubilize sulfates and nitrates found on the surface of the particles, which are water soluble. Mercury may then be removed from the particle (e.g., via heat treatment). Regeneration of adsorbent magnetic particles provides a number of advantages, such as reducing the cost of pollutant removal by allowing reuse of particles and minimizing the cost of disposing of spent particles.

System and Method for Removal of Air Pollutants using Adsorbent Magnetic Particles

One or more embodiments of the present invention also include a system and/or a method for removing pollutants from a gas stream using one or more different types of adsorbent magnetic particles described herein. Unless otherwise specified, a system and/or a method for removing pollutants from a gas stream can employ any of the various embodiments of adsorbent magnetic particles described herein, such as layered, composite, foamed, and fine adsorbent magnetic particles. Further, such a system may be used with other adsorbent magnetic particles.

One or more embodiments of the system and/or method of the invention can be more readily understood by reference to FIG. 4, which illustrates an exemplary air pollutant removal system 20 in block diagram form. The exemplary removal system 20 may employ conventional systems and/or components thereof known for use in air pollutant removal systems. Such systems may be modified to include the use of adsorbent magnetic particles. For example, they may be adapted or converted to be able to use adsorbent magnetic particles by adding on additional components, such as a magnetic particle feeder 30. While FIG. 4 generally shows the various components of the system 20 for air pollutant removal, the system 20 may also include additional devices not shown in the figure that provide supplemental or supporting roles.

As shown in FIG. 4, a gas stream source 22 provides a gas stream that is directed through the conduit 24 to a particle collector 26. The gas stream may continue through the particle collector 26 to one or more other components, such as an exhaust port 28. Adsorbent magnetic particles are introduced into the conduit 24 by a magnetic particle feeder 30. The magnetic particles intermix with the gas stream and are collected or otherwise gathered together with any waste dust present as waste material in the particle collector 26. Waste material including adsorbent magnetic particles 10 is removed from the particle collector 26 and delivered to particle separation and/or disposal apparatus 32.

The gas stream source 22 is the original source of air pollutant that is being cleaned by the system 20 of the invention. The gas stream source 22 may be any point source of air pollutants. Point sources include major industrial facilities like chemical plants, steel mills, oil refineries, power plants, and hazardous waste incinerators. Point sources generally produce energy by combustion of material such as coal or natural gas, which also releases various gases and pollutants. Such gas stream sources 22 for the present invention may include manufacturing or power plants. Utilities are estimated to currently be producing 11 million tons of SO₂, 5 million tons of NO_{X}, and 48 tons of mercury per year in the United States alone. However, while large quantities of air pollutants are released, these are present at relatively low concentrations in the flue gas stream, with SO₂ being present at about 500 ppm and NO_{X} present at about 300 ppm. The other gases making up the bulk of the gas stream are typically those produced by combustion, including carbon dioxide, carbon monoxide, nitrogen, oxygen, and water vapor. The temperature of the gas stream may vary over a wide range, but is typically about 100° to about 200° C. in the conduit 24 region of the air pollutant removal system 20.

An additional component of the gas stream may be fly ash. Fly ash includes minerals such as clay, quartz, and feldspar that solidify from the molten state in the moving air stream to form particles. Approximately 60% of the fly ash particles form a spherical shape. Rapid cooling of the ash from the molten state as it leaves the flame causes fly ash to be predominantly noncrystalline (glassy) with minor amounts of crystalline constituents. Fly ash varies in size and composition based on its source and the conditions of combustion, but is generally 250 μm or smaller, and has an average size of about 45 μm. Fly ash is generally categorized as Class C or Class F, and is composed primarily of SiO₂, Al₂O₃, Fe₂O₃, and CaO. In the year 2002 in the United States, 76.5 million tons of coal fly ash were produced. In embodiments of the invention in which calcium carbonate is injected into the gas stream, an additional component of the waste material in the gas stream may be gypsum, which is formed by the reaction between calcium carbonate and sulfur oxides.

The conduit 24 is operably connected to the gas stream source 22 and serves to carry gases of the gas stream (e.g., flue gases) away from the site of combustion. The conduit 24 is generally part of the air quality control system of a point source of air pollutants, and is formed using a duct with optional auxiliary equipment such as hoods, fans, and cooling systems. The type of duct is generally selected from the group including water-cooled, refractory lined, stainless-steel, and carbon-steel ducts. Factors considered in duct design are the avoidance of pressure loss due to friction, and resistance to corrosion by the gas stream that passes through the duct forming the conduit 24.

The system 20 for removing air pollutants also includes a particle collector 26 that removes particulate matter from the gas stream flowing through the conduit 24. Particulate matter typically constitutes a major component of air pollutants. Particulates have a variety of shapes and sizes, and can be either liquid droplets or dry dusts with a wide range of physical and chemical properties. Particulate matter in the system 20 of the present invention also includes adsorbent magnetic particles that have been introduced into the gas stream. Particulate matter ranges in size from 0.001 microns to 1 mm; however, fly ash particulate matter found in flue gases generally ranges from about 1 to 300 microns (μm), with the majority of the particulate matter having a size from about 5 to 50 microns. As noted herein, the adsorbent magnetic particles of the invention generally have a nominal diameter of 100 microns (μm) or less, though in particular embodiments the particles may have a nominal diameter of about 75 microns, 50 microns, or even 25 microns or less.

A variety of particle collectors 26 may be used in the system 20 for removing adsorbent magnetic particles. Particle collectors 26 typically collect particles when they strike a surface as a result of impaction, interception, or diffusion, after which the particle is retained on the surface by short range forces such as van der Walls forces, electrostatic force, or chemical bonding. Any particle collector 26 utilizing these principles can be used in the system 20 of the present invention. Examples of particle collectors 26 suitable for use in the present invention include mechanical separators such as gravity settlers or cyclones, fabric filters such as those used in a baghouse, electrostatic precipitators, and wet scrubbers. Some embodiments of the invention include the advantage of using particle collectors 26 that are already present in an existing facility, which generally decreases the cost of preparing the pollution removal system and avoids additional pressure drop across the system that would likely be caused by the installation of additional pollution removal equipment. Particle collectors 26 that are present in an existing pollution removal system are referred to herein as existing particle collectors, and can be distinguished from “add on” particle collectors that must be added to a system that includes a gas stream bearing pollutants to accommodate the use of pollutant removing particles.

In some embodiments of the invention, particles may be used that are water-sensitive, in which case the particle collectors 26 used should employ dry separation methods. For example, magnetic oxidizing particles of the invention are generally water-sensitive, as the oxidizing agent layer is generally very soluble in aqueous solution. Examples of particle collectors 26 that use dry separation methods include gravity settlers or cyclones, fabric filters such as those used in a baghouse, and electrostatic precipitators.

A cyclone particle collector removes particles by causing the gas stream to flow in a spiral pattern outside of a tube. Centrifugal force causes the larger particles to move outwards and collide with the wall of the tube, after which they slide down the wall to the bottom of the cyclone where they are collected. A fabric filter such as that used in a baghouse, on the other hand, operates on the same principle as a vacuum cleaner. Gas carrying particles (e.g., dust and/or adsorbent magnetic particles) are forced through a cloth bag, and the particles accumulate on the cloth, resulting in a cleaned air stream. Accumulated particles are removed by shaking the filter or reversing the airflow. An electrostatic precipitator applies electrical force to separate particle from the gas stream. A high voltage drop is established between electrodes and particles passing through the device, causing the particles to develop a charge. The charged particles are then attracted to an oppositely charged plate, where they are removed and collected by shaking. Finally, wet scrubbers collect particles by their impaction and interception by droplets of water, which are then separated from the gas stream by gravity.

A commonly used particle collector 26 for the invention is a fabric filter such as that used in bag houses. Fabric filters can handle many types of particles and provide high efficiency removal. Bag house filtration provides a number of advantages; it has high collection efficiencies, can operate on a wide variety of particles, can operate with a relatively low pressure drop, and are typically modular in design and can be readily assembled at the site where air pollution control is being conducted. Bag houses can use fabric filters made from a wide variety of fabric materials, including, for example, dynel, cotton, wool, nylon, polypropylene, orlon, dacron, Nomex™, Teflon™, and glass. The bag house functions by trapping particles on the fabric while allowing gas to pass through. However, it is worth noting that the particulate layer that forms on the fabric is often a more efficient filter than the fabric itself. The fabric filter is generally formed into an elongated bag, with air flow through the bag trapping the particles either on the inside or outside of the bag, depending on the direction of air flow. Generally, larger particles prefer a higher filtering velocity, while smaller particles prefer a lower filtering velocity. The particle fibers used are generally about 100-150 μm in diameter, and leave open spaces between the fibers of about 75 μm or less. Fabric selection should be made based on the desired particle release properties, gas stream characteristics, and the type of particulate.

Bag house designs known by those skilled in the art include reverse-air and shaker bag houses, as well as pulse-jet bag houses. Reverse-air and shaker bag houses are generally constructed with several compartments to allow portions of the bag house to be taken off line while particles are removed from the fabric filter. The name of these bag house designs refers to the method used to dislodge particles that have accreted upon the fabric filter surface. In reverse air bag houses, particles are dislodged by reversing the air flow, while in shaker bag houses the bags are shaken. More recently, sonic blasts have also been utilized to dislodge particles from the fabric filter. Dislodged particles are collected in a hopper below the fabric filter bags. In pulse-jet bag houses, the bag is formed onto a cage that prevents the bag from collapsing, and air is filtered from the outside to the inside, resulting in particle deposition on the outside of the bag. The bags are cleaned by short blasts of high pressure air. Embodiments of the particle collector 26 may use any of these known designs or any other method for using fabric filtration to remove particulate matter (e.g., dust and/or adsorbent magnetic particles) from the gas stream.

The air pollutant removal system 20 may include multiple particle collectors. For example, particle collection may be accomplished by using a cyclone particle collector first, which is more effective for removing large particles, followed by a baghouse to collect the finer particles. One or more embodiments of the invention may also use both electrostatic and baghouse particle collectors. Depending on the size of adsorbent magnetic particles being used in the invention, they may be preferentially collected in specific particle collectors in the particle collector 26 system when multiple particle collectors are used. The adsorbent magnetic particles are approximately the same size as the other material (e.g., fly ash dust) being trapped by an existing conventional particle collector 26 in an air pollution removal system, avoiding the need to provide additional or new types of particle collectors 26 to collect the adsorbent magnetic particles. Use of multiple particle collectors may be advantageous when particles of different sizes are used. For example, different particle collectors may be used when fine adsorbent magnetic particles (with a nominal diameter of about 50 microns or less) are used together with magnetic oxidizing agents (with a nominal diameter of about 100 microns or less), in order to separate these differently sized magnetic particles.

The reaction zone for the present invention includes the area within the system in which the adsorbent magnetic particles are able to interact with the gas stream containing air pollutants. Generally, this includes a portion of the conduit downstream from the magnetic particle feeder 30 as well as the particle collector 26 where adsorbent magnetic particles may reside and be exposed to the gas stream for an extended period of time before being removed from the system. The reaction zone should generally allow the adsorbent magnetic particles to contact the gas stream for a sufficient length of time to enable a significant amount of the air pollutants to be captured by the adsorbent magnetic particles.

Adsorption of airborne pollutants may occur anywhere within the reaction zone. However, in different embodiments, adsorption of airborne pollutants occurs to a greater extent in certain portions of the reaction zone. For example, in one embodiment of the invention using a fabric filter particle collector 26, adsorption of airborne pollutants may predominantly occur while the adsorbent magnetic particle is trapped within the fabric filter. Alternately, in other embodiments of the invention, adsorption of airborne pollutants may occur predominantly during travel through the gas stream prior to capture by the particle collector 26, i.e., while “in flight.” For example, adsorbent magnetic particles including metal sulfides such as molybdenum disulfide (MoS₂) provide particularly rapid adsorption of pollutants, and may adsorb airborne pollutants predominantly while in flight. Embodiments of the invention in which airborne pollutants are predominantly adsorbed while in flight facilitate the use of particle collectors 26 such as electrostatic precipitators, which have the advantage of providing a lower pressure drop.

The temperature in the reaction zone is generally high enough to promote ready reaction between the gas stream and the adsorbent magnetic particles, but low enough that particle decomposition is avoided. For example, as nitrates of manganese decompose at temperatures of about 260° C., the temperature of the reaction zone in embodiments of the invention using particles including manganese would typically be kept below 260° C. Temperatures above 100° C. are usually desirable to avoid water vapor condensation.

In some embodiments of the invention, additional materials may be injected into the conduit 24 to facilitate pollution removal. For example, embodiments of the invention where fine magnetic adsorbent particles (e.g., fine uncoated magnetite particles) are injected into the gas stream, the system may also provide for injection of magnetic oxidizing particles into the gas stream. Magnetic oxidizing particles may be co-injected in the same magnetic particle feeder 30 that is used to inject the fine magnetic adsorbent particles (e.g., uncoated magnetite particles), or they may be injected from another magnetic particle feeder 30 that is placed nearby. In other embodiments, non-magnetic materials such as oxidizing agent, calcium hydroxide, or calcium carbonate may be delivered to the conduit by suitable feeder devices.

Embodiments of the air pollutant removal system 20 may include an exhaust port 28 to release the gas stream into the atmosphere after it has been cleaned by the particle collector 26 and any other pollution control devices that may be present in the system 20. For a large point source of air pollution, the exhaust port 28 will include a stack to raise the gas stream many feet above ground level to aid in dispersion of the gas upon release into the atmosphere. While not shown in FIG. 4, the air pollutant removal system 20 of the present invention may also include various air pollutant removal systems to supplement the adsorbent magnetic particles. Supplemental pollutant removal systems include, for example, volatile organic compound (VOC) incinerators, fixed-bed adsorption systems, fluidized-bed adsorbers, gas absorption towers, and limestone scrubbing.

In a further embodiment of the invention, the system 20 may include an adsorbent filter 34, as shown in FIG. 5. While the adsorbent filter 34 may be used at any point within the air pollutant removal system 20, it is preferably positioned to filter the gas stream after it has flowed through the particle collector 26, but before it leaves the system 20 through the exhaust port 28. The adsorbent filter 34 provides additional air pollutant removal beyond that generally afforded by the adsorbent magnetic particles. The adsorbent filter 34 is a filter that has been coated along at least a surface portion thereof (e.g., its interior surfaces) with adsorbent material. The adsorbent material removes additional air pollutants from the gas stream by adsorbing them upon the surface portion. The adsorbent filter may be any shape that provides a high surface area for good exposure of coated adsorbent material to the gas stream. An example of this sort of filter is a ceramic honeycomb monolithic block filter bank, such as the Celtex™ extruded ceramic metal filter produced by Corning (Troy, Mich.).

Various metals, metal oxides, and metal sulfides are well suited for use as adsorbent material in the adsorbent filter 34. Metal oxides may include oxides of manganese, magnesium, calcium, silicon, titanium, scandium, chromium, nickel, copper, zinc, aluminum, yttrium, rhodium, palladium, silver, cadmium, and various combinations thereof. Metal sulfides include, for example, molybdenum disulfide. A number of embodiments of the invention use various manganese oxides, as manganese oxides are an effective adsorbent for mercury and other pollutants such as sulfur oxides and nitrogen oxides. Manganese oxides include, for example, Mn₂O₃, Mn₃O₄, and MnO₂. Metals such as iron, gold, silver, and copper may also be used in the adsorbent material. In some embodiments, the adsorbent filter 34 may be coated with the adsorbent magnetic particles described herein. However, although the adsorbent filter 34 may be coated with adsorbent magnetic particles, non-magnetic sorbent materials may also be used. Sorbent material or adsorbent magnetic particles may be coated onto the adsorbent filter 34 using a variety of techniques known to those skilled in the art, such as chemical deposition, spray atomization, or sol-gel thin layer deposition. Sol-gel may be used to attach various materials, and is further described in “Introduction to Sol Gel Processing” by Alain C. Pierre, Kluwer Academic publishers, Boston/Dordrecht/London, 1998.

The adsorbent filter 34 may be periodically cleaned. For example, it may be washed to remove soluble air pollutants such as soluble sulfate and nitrate salts. The adsorbent filter 34 may be washed within the system, or it may be removed for maintenance and washed in isolation. During the washing process, adsorbent magnetic particles may detach from the adsorbent filter 34. These particles may be magnetically collected and optionally regenerated and recycled as described herein. The adsorbent filter 34 may also be fully regenerated using the adsorbent particle regeneration methods described herein.

In an alternate embodiment, the adsorbent filter 34 is not a static filter, as just described, but rather is a dynamic filter that uses elements (e.g., metal or fiber optic cables) coated with sorbent material that pass through the gas stream to adsorb pollutants. To distinguish this type of adsorbent filter 34 from the static adsorbent filter 34 described above, this type of adsorbent filter 34 is referred to herein as a dynamic adsorbent filter. The dynamic adsorbent filter has the advantages of providing a large surface area for potential adsorption, while allowing continuous regeneration of sorbent material that has been placed on the cables. The sorbent materials used to coat the cables of the dynamic adsorbent filter may be any of the sorbent materials described above for use with the adsorbent filter 34, such as metals, metal oxides, and metal sulfides. One or more embodiments of the filter may also include very thin coatings of sorbent material on the cables that provide a nanostructured layer with a relatively high surface area (i.e., a surface area of 100 m²/g or more).

The moving cables provide the dynamic aspect of the dynamic adsorbent filter. The cables may run through any portion of the gas stream (e.g., a portion of the conduit 24). The cables may move through the conduit parallel to the gas steam, or they may be run perpendicular to the gas stream, or any other angle relative to the gas stream that is desired. The cables should have a fairly small diameter, ranging from about 0.1 mm to about 5 mm. The cables can be formed from a variety of materials. For example, the cables may be formed from fiber optic cable material which is inexpensive, readily available, and can be easily bonded to sorbent materials. One or more cables may be run through the gas stream. When more than one cable is used, the cables may be bundled together if desired.

The cables may enter and leave the conduit 24 through cable openings in the conduit 24. The cable openings may be high temperature perforated gaskets to minimize leakage from the conduit 24. The cables are generally in motion so that the portion of cable that is in the gas stream changes over time. The cables may either be moved continuously, or they may be moved periodically. The cables are moved and supported by a pulley system which may be driven by a motor, or any other cable movement system known to those skilled in the art. The sorbent material on the portion of the cable that is in the gas stream adsorbs pollutants. The sorbent material on the portion of the cable that is outside the conduit may be regenerated to remove pollutants and restore the sorbent material. The sorbent material may be regenerated using any of the procedures described herein. For example, the sorbent material may be regenerated by heat treatment, or the sorbent material may be regenerated by chemical treatment in which the sorbent material is washed off of the cable, chemically regenerated, and then placed back onto the cable.

While the dynamic adsorption filter has been described above as an adsorbent filter 34 that is used to supplement pollution removal by adsorbent magnetic particles, the dynamic adsorption filter may also used independently in a pollution removal system that does not use adsorbent magnetic particles. In an independent system, the dynamic adsorption filter would be installed in the conduit 24, and the magnetic particle feeder 30 and the particle collector 26 may not be needed.

The system 20 also includes a magnetic particle feeder 30 that delivers adsorbent magnetic particles to the conduit 24 in which they adsorb air pollutants from the gas stream while within the reaction zone. Adsorbent magnetic particles may be injected into the gas stream at a point in the conduit 24 where the temperature of the gas stream is in the range of about 100° C. to about 250° C.; typically, downstream from a heat exchanger. A single magnetic particle feeder 30 may be used, or multiple feeders may deliver adsorbent magnetic particles at multiple points on the conduit 24.

The magnetic particle feeder 30 typically contains a sufficient supply of adsorbent magnetic particles to avoid frequent refilling, and may be heated to provide adsorbent magnetic particles preheated to a temperature at which they will more readily react with air pollutants in the gas stream. The magnetic particle feeder 30 should deliver adsorbent magnetic particles to the gas stream at an appropriate rate, based on the volume of gas flowing through the conduit. In some embodiments of the invention, a magnetic particle feeder 30 may also be used to deliver additional magnetic particles, such as magnetic oxidizing particles, to the gas stream. Any feeder system capable of supplying a stream of adsorbent magnetic particles into the gas stream may be used. Exemplary particle feeders include dry sorbent feeders with rotary valves. As noted elsewhere, an advantage of the present invention is that an existing pollution control system can be readily adapted to use the adsorbent magnetic particles of the invention simply through addition of a magnetic particle feeder 30 to a gas stream conduit 24.

As described above, after injection into the gas stream, the adsorbent magnetic particles travel with the gas stream until they are captured by the particle collector 26. Flight time within the gas stream is generally only a few seconds, but will vary depending on the length of the gas stream conduit 24 and the velocity of the gas stream. Adsorbent magnetic particles react with air pollutants during the time while they are within the reaction zone. Adsorbent magnetic particles are then either continuously or periodically removed from the particle collector 26, along with any other particulate matter that may have been captured, for provision to the particle separation and/or disposal apparatus 32. In one or more embodiments, adsorbent magnetic particles, together with any other waste particles present, may be disengaged from the particle collector 26 by vibrating or aerating the plates or bags in which the particles have collected to shake loose the particles, as described above for particle collection systems.

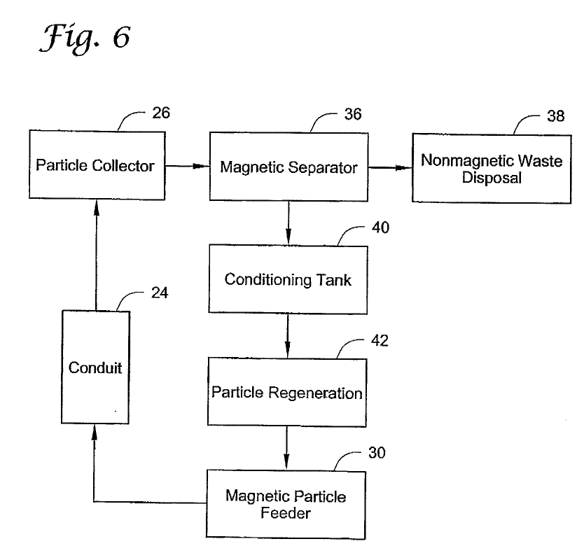

The particle separation and/or disposal apparatus 32 of the system 20 may include a variety of methods for handling the collected particles. For example, the particles may simply be disposed of as waste material. In other embodiments, the particles are subjected to wet or dry magnetic separation, as shown in FIG. 6, to remove adsorbent magnetic particles from the other waste particles present in order for them to be handled separately. Embodiments of the magnetic separation aspect of the invention may remove 95% or more of the adsorbent magnetic particles from other waste materials such as fly ash.

One exemplary embodiment for handling the material retrieved from the particle collector 26 is shown in more detail in FIG. 6. In this embodiment, the particle separation and/or disposal apparatus 32 may include a magnetic separator 36 to remove the adsorbent magnetic particles from other particles trapped by the particle collector 26. The magnetic separator 36 is operably connected to the particle collector 26, and is used to separate non-magnetic waste material from adsorbent magnetic particles. Operably connected does not imply that the magnetic separator is physically connected to the particle collector 26, though in some embodiments it may be. For example, the magnetic separator may be a separate component which is nonetheless readily available for separation of particles collected in the particle collector 26. In some embodiments, the magnetic separator 36 is also used to separate other types magnetic particles, such as magnetic oxidizing particles. A wide variety of devices and methods are available for separating magnetic particles such as adsorbent magnetic particles from other materials such as fly ash. These magnetic separation devices are generally categorized as either wet or dry magnetic separation.

In one example of dry magnetic separation, the magnetic separator 36 may be a an electromagnetic drum, similar in design to those used in coal burning plants to collect magnetite added to coal processing water. The drum pulls magnetic particles out of a particle mix, leaving the relatively non-magnetic particles and redirecting the attached magnetic particles to a separate handling pathway. A conveyor belt may be used to carry particles to and from the electromagnetic drum. The isolated non-magnetic particles may then be removed for nonmagnetic waste disposal 38.

Embodiments using magnetic separation to process the material retrieved from the particle collectors 26 have the advantage of producing waste material that is relatively mercury-free, as the adsorbent magnetic particles should carry the bulk of the mercury that was present in the gas stream, and these adsorbent magnetic particles are removed from the non-magnetic waste. The adsorbed magnetic particles retaining pollutants such as mercury may then be disposed of separately (not shown on FIG. 5). Alternately, they may be regenerated for reuse within the airborne pollutant removal system 20 and eventually returned to the magnetic particle feeder 30. For dry magnetic separation, the conditioning tank 40 shown in the figure is generally not needed.

As noted earlier with reference to particle collectors, dry separation methods should generally be used for particles that are water-sensitive, such as magnetic oxidizing particles. Magnetic separation for pollution removal systems using fine adsorbent particles (e.g., uncoated magnetite particles) may result in the separation of both fine adsorbent magnetic particles and magnetic oxidizing particles. However, as both of these particles have a common core in some embodiments of the invention (an iron oxide core with a nominal diameter of 50 microns or less), co-separation of these types of particles does not create a significant problem as removal of the oxidizing agent layer will result in a mixture of essentially identical fine adsorbent magnetic particles.

The present invention may also use wet magnetic separation in which a liquid such as water is used as the particle carrier. For examples of wet magnetic separation systems, see U.S. Pat. No. 6,383,397, entitled “Method for separating magnetic particles mixed in fluid, separating system, and separator”, issued May 7, 2002 to Kojima, and U.S. Pat. No. 6,325,927, entitled “Magnetic separator apparatus”, issued Dec. 4, 2001 to Green.

In one example of wet magnetic separation, the particles captured by the particle collector 26 are mixed with a liquid such as water to form a slurry in a conditioning tank 40. The slurry is then introduced into a wet magnetic separation device where the adsorbent magnetic particles are removed by deflection of the magnetic particles into a separate stream using a magnetic field. As with the dry magnetic separation technique described above, the isolated non-magnetic particles are delivered to nonmagnetic waste disposal 38, while the adsorbent magnetic particles are either disposed of separately or conditioned and then run through a particle regeneration 42 procedure for recycling to the magnetic particle feeder 30.

Note that for both wet and dry separation, magnetic particles that have not yet been saturated with pollutants can be recycled for reuse without going through the regeneration process. Note also that material described as “waste material” in the application may often be suitable for recycling for another purpose as well. For example, soluble sulfate and nitrate salts washed from the surface of adsorbent magnetic particles may be recycled and sold as sulfate and nitrate fertilizers.

As indicated by FIG. 6, adsorbent magnetic particles may be regenerated so they can be recycled for reuse and returned to a magnetic particle feeder 30. After being magnetically separated, the particles may then be conditioned in a conditioning tank 40 and then regenerated in a particle regeneration subsystem 42. Use of the conditioning tank 40 is optional, and may not be necessary for certain types of particles or particles in a certain state of wear or bearing certain pollutants. The conditioning tank 40 may be used to allow material associated with the adsorbent magnetic particles such as those obtained from the magnetic separator 36 to go into solution. The conditioning tank 40 may also serve to remove outer reacted layers of the adsorbent magnetic particles. As removal of the outer reacted layers on an adsorbent magnetic particle may reveal un-reacted sorbent material, conditioning alone may serve to provide adsorbent magnetic particles ready for re-use.

While one or more embodiments of the adsorbent magnetic particles of the present invention are generally relatively inexpensive, recycling of the particles and/or particle adsorbent may provide additional cost advantages and may avoid the disposal costs associated with pollutant-laden particles. A variety of regeneration techniques are suitable for regenerating adsorbent material used in the adsorbent magnetic particles of the invention. For example, typical adsorbent regeneration techniques may include contacting the adsorbent with a hot inert gas, heating the particles in a kiln to cause thermal decomposition, contacting the particles with low-pressure steam, and/or pressure reduction, also referred to as pressure swing absorption. When applying heat to induce particle regeneration, the particles are generally heated to a temperature above the thermal decomposition temperature of the pollutant deposition products such as sulfates or nitrates that have formed on the adsorbent magnetic particle surfaces. Mercury may also be removed by heating. Examples of particles that can generally be regenerated by heating include fine adsorbent magnetic particles. Depending on the nature of the pollutants adsorbed, a variety of conditions may be employed to remove pollutants from the adsorbent material. Adsorbent material may be regenerated while retained on the adsorbent magnetic particles, or adsorbent material may be removed, regenerated, and then reapplied to the adsorbent magnetic particles.

Adsorbent material may also be chemically regenerated. Generally, chemical regeneration involves placing the particles in an aqueous solution to remove the sorbent material. Chemical regeneration will typically use an acid to release reacted sorbent from the surface of the particle and oxidants to convert the sorbent back to its original form for re-inclusion or redeposition on magnetic cores. For example, metal oxides and metal sulfides may be regenerated by dissolving used adsorbent magnetic particles in dilute acidic aqueous solution to release reacted sorbent, after which the released sorbent is oxidized to precipitate the pollutants and eventually, by increasing oxidation, to precipitate sorbent back onto adsorbent magnetic particle cores 12. An example of a method of particle regeneration can be found in Example 6.

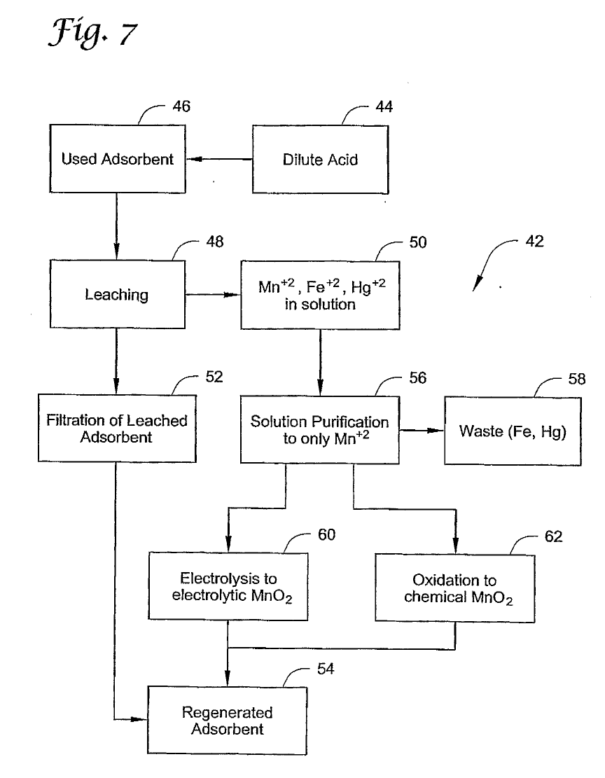

FIG. 7 shows an example of particle regeneration 42 in which adsorbent (e.g., MnO₂) recovered from adsorbent magnetic particles is chemically regenerated, as described in more detail in Example 6. Dilute acid 44 is added to adsorbent 46 that bears pollutant, whereupon impure adsorbent is leached 48 into solution 50 containing aqueous adsorbent (e.g., Mn⁺²) and possibly other ions such as aqueous iron and mercury. The leached adsorbent is then filtered 52 to provide cleaned, regenerated adsorbent 54. The solution 50 containing aqueous adsorbent is then purified 56 so that only the adsorbent material (e.g., manganese ions) remains in solution, providing waste 58 that may be removed. The purified adsorbent in solution can then be precipitated out, using electrolysis 60 or oxidation 62 to reform regenerated adsorbent 54. Note that manganese dioxide produced by electrolysis may differ in form from that produced by chemical oxidation.

Several embodiments of the present invention are illustrated by the following examples. It is to be understood that the particular examples, materials, amounts, and procedures are to be interpreted broadly in accordance with the scope of the invention as set forth herein.

### EXAMPLES

### Example 1

### Preparation of Magnetic Manganiferous Particles from Cuyuna Iron Ore

Adsorbent magnetic particles can be prepared by oxidation of manganiferous iron ores to convert them from a weakly magnetic form to a relatively strong magnetic form. Manganiferious iron ores obtained from the Cuyuna iron range region are relatively non-magnetic because they consist mainly of limonite (Fe₂O₃.nH₂O), iron carbonate, manganite (Mn₂O₃.H₂O), and often pyrolusite (MnO₂). Cuyuna iron ore was ground to −48 mesh and subjected to magnetized roasting at 700° C. in an atmosphere of 50% N₂, 42.5% CO₂ and 7.5% CO. Roasting under these conditions converts the iron oxides and carbonates into magnetite (Fe₃O₄) and reduces the various manganese oxides to MnO. The manganiferous particles were then selectively oxidized by passing them through a stream of O₂ passed through an ionizer, converting the MnO to MnO₂, resulting in particles formed primarily of an agglomerate of magnetite and manganese dioxide. Particles containing both of these materials are highly magnetic, as well as capable of removing not only metallic and oxidized mercury, but also SO_{X} and NO_{X}.

### Example 2

### Preparation of Layered Adsorbent Magnetic Particles with a Magnetite Core

One way of preparing adsorbent magnetic particles involves precipitating metal oxide materials or mixtures of metal oxide materials onto magnetic core particles. Precipitating oxides that may be used in this process include MnO₂, TiO₂, CuO, CO₃O₄, NiO₂, and Al₂O₃. Magnetite core particles ground (−325 mesh or 44 μm diameter magnetite) are placed in solution with manganese sulfate or manganese chloride that has been rendered acidic through use of nitric acid to pH 1-4, and the solution is gently stirred. An oxidizing chemical such as hydrogen peroxide, ozone, or potassium permanganate is then added to drive an oxidation reaction, with oxidant added until the oxidation reaction is complete. The formed adsorbent magnetic particles are then allowed to stand without mixing for 24 hours, after which the adsorbent magnetic particles are recovered by filtration. The adsorbent magnetic particles are typically dried at 80° C. before use in the air pollution removal system.

### Example 3

### Preparation of Layered Adsorbent Magnetic Particles Using a Binder

Magnetic Manganese Dioxide was produced by combining dry finely ground (−325 Mesh or 44 micron) magnetite from a Taconite Mining operation in NE Minnesota with dry fine (2 micron) electrolytic manganese dioxide, (EMD) using phosphoric acid as a binder. Specifically, dry magnetite concentrate is mixed with dry electrolytic manganese dioxide in a high speed mixer, with 50% strength phosphoric acid being sprayed in a fine mist into the dry mixing material. The addition of the phosphoric acid causes an exothermic binding reaction to occur and a fine micro-balled sorbent is produced in the process. Scanning electron microscope (SEM) photos of the particles reveals a high surface area component attributed to the high surface area of the EMD bound to the magnetite particles, as shown in FIG. 2.

### Example 4

### Preparation of Nanostructured Adsorbent Magnetic Particles

Manganese dioxide coated magnetite was prepared by coating finely ground (−500 mesh or 25 micron) magnetite concentrate (from a Minnesota taconite mining operation) with nanoscale manganese dioxide using a chemical deposition technique. The ground magnetite concentrate was placed in a solution of 0.4 molar manganese sulfate and heated to 50° C. Once the desired temperature is reached, 0.4 molar potassium persulfate or sodium persulfate is added to the solution to act as a strong oxidizing agent and the resulting solution is stirred vigorously and kept at 50° C. for 18 hours. The 25 micron-sized magnetite particles act as nucleation sites for the formation of high quality gamma-form manganese dioxide, which forms over the 18 hour time period at this temperature. Magnetite particles thus act as substrates upon which nanoscale manganese dioxide deposits upon and ‘coats’ during the reaction process. During the 18 hr heat treatment process, manganese dioxide is seen to form and changes from a dark brown to black color. A final heat treatment stage is then initiated to heat the reaction mixture from 50° C. to 100° C. over a one hour period, raising the temperature in 10 to 15 degree Celsius increments. The final solution is then heated at 100° C. for one hour. The solution is allowed to settle, filtered, and washed with distilled water to leave a final solution pH of 3-5. During the entire heat treatment stage, the pH of the solution is maintained at pH 0.3 and the Eh of the solution is +1000 mv. The filtered product, which is manganese dioxide coated magnetite, appears very black in color and is highly magnetic. All coated magnetite particles produced in this manner are highly magnetic and are completely held up in a Davis Tube magnetic separator (field strength of 4000 gauss) magnetic field. This technique allows for the preparation of highly effective magnetic sorbent for mercury removal produced by combining top down nanoscale methods (the use of finely ground magnetite) to bottom up nanoscale methods (the chemical deposition methods).

### Example 5

### Pollutant Adsorption by Adsorbent Magnetic Particles

A variety of adsorbent magnetic particles were evaluated in a glass reactor unit set up in a downflow test position at a coal-fired power plant. A heated Teflon gas sampling line was installed to deliver representative gas samples taken from a 2,000 cubic feet per minute ESP discharge duct to the glass reactor unit using a bench scale vacuum pump assembly. The glass reactor unit was a 250 ml glass column equipped with a fused glass frit sample base and used in a gas downflow position. The reactor was maintained at 250° F. using a convection oven. Flue gas flow was held to 5.0 liters/minute. The adsorbent magnetic particle sample size was 0.10 to 0.15 grams, held on a 1.0 cm glass fiber filter paper support. Mercury analysis was conducted using a combination of a Frontier Geosciences™ mercury gas sampling unit with a 20 minute sampling time followed by mercury laboratory analysis using a Tekran™ CVAF, Model 2600. The mercury removed includes both elemental and oxidized forms. The particles listed removed the percent of mercury indicated:
1. Magnetite Coated with MnO₂ using washcoating or electrostatic precipitation removed 75% mercury. This could be increased to 90% if non-adsorbent sand was mixed in. These particles also removed 50% of the NO_{X} present, and 80% of the SO₂ present.
2. Cuyuna Range Iron/Manganese ore, heat-treated in ozone to provide magnetite and MnO₂ removed 51-82% mercury.
3. Copper-coated magnetite particles, prepared by an electrolytic technique removed 46-58% of the mercury.
4. Maghematite particles (magnetite heated to 400° F. for 10 minutes) removed 30% mercury.
5. Magnetite coated with MnO₂ using chemical bonding with sodium silicate binder removed 50-95% mercury, 50-75% SO₂, and 25-50% NO_{X}.
6. Magnetite coated with MnO₂ using phosphate binders removed 75-97% mercury, as well as >50% of the NO_{X} present, and >75% of the SO₂ present
7. Magnetic Iron/Manganese spinel particles produced chemically and following heat treatment removed 50-95% mercury, 50-75% SO₂, and 25-50% NO_{X}.

### Example 6

### Conditioning and Regeneration of Adsorbent Magnetic Particles

Magnetite particles coated with an adsorbent including MnO₂ mixed with flue gas particles were separated and regenerated using the following procedure. Used adsorbent magnetic particles combined with other flue gas particles obtained from the particle collector of an air pollution removal system of the invention are first washed in a conditioning tank with a sufficient amount of water. The conditioned particles are then subjected to wet magnetic separation in which the clean magnetite core is removed from the slurry stream, leaving the adsorbents used to coat the particle in solution. The remaining liquid is then reduced to a pH of about 5 using nitric and/or sulfuric acid. Oxygen and ammonia gases are then added to the liquid. This causes all of the non-manganese compounds present to precipitate as oxides. When SO₂ and NO_{X} are present as pollutants, this typically results in the formation of ammonium nitrate and ammonium sulfate. The precipitated sludge is then separated by trapping it on a filter, resulting in a solid containing ammonium salts of pollutants, mercury, combustion ash, and various other materials. Typically, this solid is treated to remove mercury.

The clean magnetite core particles removed earlier are than reintroduced to the filtered liquid and the pH of the mixture is increased to 9 using additional ammonia gas and oxygen. Addition of excess ammonia and oxygen cause the manganese present in solution to precipitate back upon the magnetite cores, reforming adsorbent magnetic particles. This reaction proceeds as shown:

NH₃+O₂+Mn(NO₃)₂→NH₄NO₃(aq)+MnO_{2(on magnetite core)}

NH₃+O₂+MnSO₄→(NH₄)₂SO₄(aq)+MnO_{2(on magnetite core)}

The reformed adsorbent magnetic particles are then removed from solution using wet magnetic separation. The particles may be allowed to precipitate and dry before use. The remaining liquid phase can then be stripped of remaining compounds using, for example, electrolytic recovery or precipitation. In electrolysis, an electrolysis cell coupled with an anionic exchange membrane isolating the anode from the feed compartment, and a cathode exchange membrane isolating the cathode from the feed membrane is used. Electricity drives the process, which forms oxygen gas and a mixture of nitric and sulfuric acid in one chamber, while forming hydrogen gas and ammonium hydroxide in the other chamber. Ammonia gas can then recovered by heating or depressurizing the ammonium hydroxide, leaving behind clean water for recycling. Alternately, if precipitation is used, lime is added to cause the precipitation of calcium sulfate and ammonia gas. The precipitate can then be filtered to produce gypsum and ammonium nitrate solution, which could be dried and sold as fertilizer or electrolytically cleaved, as described, to produce additional ammonia gas.

### Example 7

### Air Pollutant Removal Using Finely Ground Magnetite

Finely ground magnetite was shown to efficiently remove oxidized forms of mercury in stack gasses at Minnesota Power's Clay Boswell coal fired power plant in Cohasset, Minn. Magnetite used for this work was natural magnetite obtained from Minnesota Taconite operations, ground to −500 Mesh (25 micron) size. This material is typically sold for about $20/ton and is thus an extremely low cost sorbent for use in removing oxidized and elemental forms of mercury in power plant stack gas. Much of the mercury emitted by Eastern United States coal burning power plants exists in oxidized forms of mercury which experiments revealed was efficiently captured by injecting dry finely ground magnetite, alone and untreated, into power plant stack gas streams.

When finely ground dry magnetite was injected into the coal fired power plant stack gas stream as described above, 95% of the oxidized mercury was removed, as well as 20% of the elemental mercury.

The dry, finely ground magnetite may be injected through gas nozzles into the stack gas stream after the air heater units in coal burning power plants. Air heater units cool hot stack gases down to about 300-400° F. The injected magnetite containing the sorbed oxidized mercury is then be picked up by the particulate control systems (e.g., baghouses, electrostatic precipitators, or dry or wet scrubbers) in the power plants and removed from the surrounding fly ash via wet or dry magnetic separation. Mercury is then removed from the magnetite via water washing, acid washing, or heating to between 400 and 700° F. in an air or nitrogen atmosphere. Mercury in solution can then be electroplated out of solution or precipitated as an insoluble sulfide, for example. Mercury vaporized out via the heating procedure is condensed out as liquid mercury. Collection of liquid mercury then allows mercury to be completely removed from the environment. Magnetite is thus regenerated for re-use and may then be re-injected in the stack gas stream for continuous mercury removal.

### Example 8

### Air Pollutant Removal using Adsorbent Magnetic Particles including Molybdenum Disulfide

Magnetic forms of molybdenum disulfide were prepared and shown to efficiently remove oxidized and elemental forms of vapor phase mercury from industrial stack gases, with special reference to stack gases emitted from coal burning power plants. Molybdenum disulfide powder (5 to 75 microns in diameter) was mixed with magnetite powder (5 to 75 microns in diameter) in a dry form to produce a dry composite powder that was then mixed with 50% phosphoric acid binder to form a paste. A 75% magnetite and 25% molybdenum disulfide ratio (by weight) was used to form the magnetic composite. Colloidal silica may also be used as a type of binder (10% to 20% Colloidal silica by weight) in spray drying. The resulting paste, using the phosphate binder, was oven dried and then ground in a ball mill or pulverized to −200 mesh (75 microns). The dry power was then injected into a 250 cubic feet per minute (cfm) stack gas stream at Minnesota Power's Clay Boswell Generating Plant. Oxidized and elemental vapor phase Mercury was effectively removed (>90%), as well as sulfur dioxide, which was also efficiently removed (>90%). The magnetite (Fe₃O₄) used was natural Magnetite obtained from a Minnesota Taconite operation mining iron ore. Molybdenum disulfide was purchased from a chemical supply company (Fisher Scientific, Fairlawn, N.J.).

One advantage of the magnetic molybdenum disulfide sorbent produced in this manner is that it can capture elemental and oxidized forms of vapor phase mercury “in flight” prior to hitting the baghouse as these particles traveled in the stack gas stream on their way to the baghouse. This facilitates the use of magnetic molybdenum disulfide sorbent in conjunction with electrostatic precipitator (ESP) particulate removal systems that do not utilize filter bags to remove particles. ESP units pull particles onto charged plates and do not physically obstruct the air stream as do baghouses. After the magnetic molybdenum disulfide is taken out of the stack gas stream along with the flyash, using standard baghouse or ESP collectors, it can be efficiently separated from the flyash using dry or wet magnetic separation. Once separated from the flyash via the magnetic separation, the magnetic molybdenum disulfide can then be regenerated and reused again and again to remove mercury and sulfur dioxide pollutants.

### Example 9

### Preparation of Adsorbent Particles Using Spray Drying

Magnetic air pollutant sorbents were typically produced by blending magnetite powder with various mercury sorbent chemicals in the presence of a chemical binder to form a magnetic agglomerate, and then drying and grinding the agglomerate to produce a final product in the form of a dry, high surface area powder. In some cases, the final dry grinding process deteriorates the bonding mechanism and ability of the chemical binder added to bind the magnetite powder to the various mercury sorbent chemicals. Therefore, a new process was sought after to form the powder-like magnetic sorbent particles in a dry form and in a small size range (10 microns to 100 microns). Spray drying was found to be an excellent method to form dry, magnetic mercury sorbent particles in the size ranges needed without the necessity of having to dry and grind larger magnetic sorbent particles, and can be readily used to provide quantities of particles at the industrial scale.

To prepare adsorbent particles by spray drying, binding agents were introduced in one process stream into the spray drying nozzle while slurries containing magnetic iron oxides and other metal oxides and/or chemical oxidizing agents requiring binding were introduced into another process stream fed into the same spray drying nozzle. The separate slurry streams were then mixed in the spray nozzle and collectively sprayed as slurry droplets into the heated chamber section of the spray dryer. When used at a typical power plant, heat exchangers could be installed in the stack gas stream to provide the heat to the spray dryer. The fine slurry droplets containing the metal powders and binders lose water through evaporation as they travel down the spray dryer heating chamber, producing a dry fine powder composite particle in which diverse materials were held together by the binder. The spray drying process thus acts as a unique reactor in which magnetic air pollutant sorbents can be produced to form magnetic air pollutant sorbent mineral composites as well as producing them in a dry, fine particle form.

In one embodiment, electrolytic manganese dioxide (EMD) powder (5 to 75 microns in diameter) was mixed with magnetite powder (5 to 75 microns in diameter) in a 1:1 ratio (by weight) to produce a composite powder which was then mixed with water to form a slurry that was then fed into one side of a spray drying nozzle. A 50% phosphoric acid solution was then fed into a second side of the spray nozzle and both mixtures were mixed and sprayed out into the heated chamber (at 275° F.), resulting in the formation of a magnetic (magnetite-containing) EMD composite powder. Several different weight ratios of magnetite/EMD and phosphoric acid binder were prepared, with the best ratio of binder being 10% phosphoric acid by weight mixed with 90% magnetite/EMD by weight. The heat used in the spray drying process was not found to reduce the magnetic strength of the magnetite particles that form the magnetic sorbents.

Other binders besides phosphoric acid can be used to join the magnetite particles with the mercury sorbent particles using the spray drying technique. For example, colloidal silica can be spray dried together with a slurry mixture of Magnetite and Molybdenum Disulfide to form a magnetic composite of the Molybdenum Disulfide.

### Example 10

### Use of Magnetic Oxidizing Agents to Remove Hazardous Air Pollutants

Magnetic forms of air pollutant oxidizing agents were prepared and shown to efficiently remove elemental forms of vapor phase Mercury, Sulfur Dioxide, and Nitrous Oxides from coal burning power plant stack gas emissions. Magnetic oxidizing agents were produced by drying oxidizing agent salts onto finely ground (10-45 micron) magnetite powders. For example, magnetic sodium persulfate, was prepared by mixing finely ground magnetite into a saturated solution of sodium persulfate to form a mixture with a paste-like consistency. The paste was then dried at 105° C. to form a magnetic sodium persulfate powder.

The dry magnetic oxidizing agent powder was then injected into a gas stream along with various weight percentages of finely ground magnetite powder to oxidize elemental forms of vapor phase mercury to oxidized mercury forms which were then adsorbed and removed by the uncoated magnetite powder present along with the magnetic oxidizing agents. A 50/50 mixture of dry magnetic oxidizing agent and dry magnetite powder injected into the flue gas stream has been shown to be effective. Generally, the existing particulate removal systems already present at the end of coal burning power plant stack gas streams can be used to remove the magnetic oxidizing agents and magnetite particles along with the fly ash. The magnetic oxidizing agents and magnetite particles may then be removed and separated from the fly ash by magnetic separation techniques, including dry and wet high intensity magnetic separation. The magnetite and magnetic oxidizing agents may then be regenerated, while removing various forms of oxidized mercury, sulfates and nitrates.

Magnetite oxidizing agents, such as magnetic sodium persulfate, may be used with a dry fly ash removal system such as a bag house or electrostatic precipitator. When the fly ash containing the magnetic oxidizing agents and magnetite is kept dry, the magnetic separation process used to separate fly ash from magnetic oxidizing agents and magnetite, and the regeneration process for regenerating the magnetic oxidizing agent, can be carried out more easily. This is because the oxidizing agents dried onto the surface of the magnetite to make them magnetic are usually water-soluble and may wash off the surface of the particles if exposed to significant amounts of water. The water-soluble nature of the oxidizing agents is advantageous when it comes to regeneration of the particles. The water-soluble oxidizing agents can be washed to remove soluble oxidized mercury, sulfates resulting from the oxidation of sulfur dioxide, and nitrates resulting from the oxidation of nitrous oxides, off the surface of the magnetic agent.

Sodium persulfate may be used as a magnetic oxidizing agent for oxidizing and removing mercury, sulfur oxides, and nitrous oxides, and other hazardous air pollutants from industrial stack gas streams. In addition, other oxidizing agents and chemicals can be “attached” to magnetite through the drying process described. Sodium iodide, for example, may be used to remove elemental mercury in stack gas stream, and was easily coated onto the surface of finely ground magnetite by drying a saturated solution of sodium iodide, forming an excellent oxidizing agent for elemental mercury to enhance its removal from stack gas streams.

The spray drying process (described in Example 9, herein) can also be used to produce magnetic oxidizing agents, by spraying together a mixture of the magnetic particles and the oxidizing agents.

### Example 11

### Preparation of Foamed Adsorbent Magnetic Particles

Foamed iron particles were prepared through the addition of finely pulverized limestone (calcium carbonate) to a mixture of magnetite, phosphoric acid, and manganese dioxide. Note that lime may be used in place of calcium carbonate. Note also that other sorbent materials may be added, such as metal oxides, molybdenum disulfide, or other metal sulfides or a mixture of these metal oxides and metal sulfides.

The magnetite, limestone, and manganese dioxide were then mixed together (dry) and liquid phosphoric acid (50%-90% strength) was added to form a slurry paste which hardened to form a foamed magnetic iron material. When the phosphoric acid was added, carbon dioxide evolved, creating open pores or pockets in the mineral base structure.

Ranges in the amount of limestone that may be added are 5-25% of total weight (magnetite, limestone, and sorbent), 10% preferably. Ranges of sorbent compounds (oxides or sulfides or a mix of the two) that may be added are 5-25% by weight. The range of iron oxide that is provided for the mixture may range from 50%-90%, by weight.

The foamed magnetic iron mineral based material was then converted to particles by grinding the material to the desired size (−200 Mesh). Weighing the particles indicated they were significantly lighter than particles of equivalent material that had not been foamed, and observing them under the microscope revealed that a number of pores remained, as well as small flakes of unreacted calcium carbonate.

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

All headings are for the convenience of the reader and should not be used to limit the meaning of the text that follows the heading, unless so specified.

1. A particle for use in air pollutant removal, the particle comprising:
a magnetic core; and
a sorbent layer provided on at least a portion of the magnetic core, wherein the sorbent layer comprises at least one of a metal oxide, a metal sulfide, and an oxidizing agent.

2. The particle of claim 1, wherein the sorbent layer comprises at least one of a metal oxide and a metal sulfide.

3. The particle of claim 2, wherein the sorbent layer comprises a manganese oxide.

4. (canceled)

5. The particle of claim 2, wherein the sorbent layer comprises molybdenum disulfide.

6. The particle of claim 1, wherein the sorbent layer comprises an oxidizing agent.

7. The particle of claim 1, wherein the magnetic core comprises strongly magnetic iron oxide provided from an iron ore.

8. (canceled)

9. The particle of claim 1, wherein the particle further comprises a binder.

10. The particle of claim 1, wherein the particle has a nominal diameter of about 10 microns to about 100 microns.

11. The particle of claim 2, wherein the binder comprises an organic acid.

12-13. (canceled)

14. A method of preparing particles for use in air pollutant removal, comprising:
providing a plurality of magnetic cores from ground iron ore;
combining the magnetic cores with binder and at least one of a metal oxide, an oxidizing agent or a metal sulfide to at least partially coat the magnetic cores therewith; and
removing the magnetic cores at least partially coated with the metal oxide, the oxidizing agent, or the metal sulfide.

15. (canceled)

16. The method of claim 14, wherein the binder comprises at least one of an organic acid, a phosphate binder or sodium silicate.

17. The method of claim 14, wherein the at least one of the metal oxide, the oxidizing agent or the metal sulfide is selected from a group consisting of molybdenum disulfide, MnO₂, TiO₂, CuO, CO₃O₄, NiO₂, and Al₂O₃.

18. The method of claim 14, wherein the magnetic cores comprise magnetite.

19. The method of claim 14, wherein the particle has a nominal diameter of about 10 microns to about 100 microns.

20. (canceled)

21. A method for use in removing pollutants from a gas stream, comprising:
introducing adsorbent magnetic particles into a gas stream, wherein each of a plurality of the adsorbent magnetic particles comprises a magnetic core and a sorbent layer covering at least a portion of the magnetic core, wherein the sorbent layer comprises at least one of a metal oxide, a metal sulfide, and an oxidizing agent, wherein the adsorbent magnetic particles associate with pollutants in the gas stream, and further wherein the pollutants comprise at least one of mercury, sulfur oxides, and nitrogen oxides; and
removing the adsorbent magnetic particles associated with pollutants from the gas stream.

22-25. (canceled)

26. The particle of claim 21, wherein the magnetic core comprises strongly magnetic iron oxide provided from an iron ore.

27-32. (canceled)

33. The method of claim 21, wherein the method further comprises:
removing non-magnetic waste material from the gas stream; and
magnetically separating the non-magnetic waste material from the adsorbent magnetic particles associated with pollutants.

34. (canceled)

35. The method of claim 33, further comprising regenerating the adsorbent magnetic particles associated with pollutants.

36. The method of claim 33, wherein the non-magnetic waste material comprises fly ash.

37-38. (canceled)

39. A system for use in removing pollutants from a gas stream, comprising:
a conduit for receiving a gas stream from a gas stream source;
a magnetic particle feeder operable to introduce adsorbent magnetic particles into the gas stream, wherein each of a plurality of the adsorbent magnetic particles comprises a magnetic core and a sorbent layer covering at least a portion of the magnetic core, wherein the adsorbent magnetic particles associate with pollutants in the gas stream; and
a particle collector operable to remove the adsorbent magnetic particles from the gas stream after one or more adsorbent magnetic particles have associated with a pollutant in the gas stream.

40-42. (canceled)

43. The system of claim 39, wherein the sorbent layer comprises at least one of a metal oxide, a metal sulfide and an oxidizing agent.

44-46. (canceled)

47. The system of claim 39, wherein the magnetic core comprises strongly magnetic iron oxide provided from an iron ore.

48-51. (canceled)

52. The system of claim 39, wherein the particle collector is further operable to remove non-magnetic waste material from the gas stream, and further wherein the system comprises a magnetic separator operably connected to the particle collector, wherein non-magnetic waste material is separable from adsorbent magnetic particles associated with pollutant by the magnetic separator.

53-54. (canceled)

55. The system of claim 39, further comprising a particle regeneration apparatus operable to separate pollutants from the adsorbent magnetic particles.

56-57. (canceled)

58. The system of claim 39, wherein the particle collector is a bag house.

59-60. (canceled)

61. A particle for use in air pollutant removal comprising a foamed iron oxide, wherein the foamed iron oxide comprises a plurality of voids defined therein, and wherein the particle has a nominal diameter of about 100 microns or less.

62-69. (canceled)

70. A method of preparing particles for use in air pollutant removal, comprising:
using phosphoric acid and a foaming agent to foam an iron oxide, wherein the foamed iron oxide comprises iron phosphate; and
forming the foamed iron oxide into foamed particles.

71-80. (canceled)

81. A method for use in removing pollutants from a gas stream, comprising:
introducing adsorbent magnetic particles into a gas stream, wherein each of a plurality of the adsorbent magnetic particles comprise foamed iron oxide, wherein the foamed iron oxide comprises a plurality of voids defined therein, and further wherein the adsorbent magnetic particles associate with pollutants in the gas stream; and
removing the adsorbent magnetic particles associated with pollutants from the gas stream.

82-97. (canceled)

98. A system for use in removing pollutants from a gas stream, comprising:
a conduit for receiving a gas stream from a gas stream source;
a magnetic particle feeder operable to introduce adsorbent magnetic particles into the gas stream, wherein each adsorbent magnetic particle comprises foamed iron oxide, wherein the foamed iron oxide comprises a plurality of voids defined therein; and
a particle collector operable to remove the adsorbent magnetic particles from the gas stream after one or more adsorbent magnetic particles have associated with a pollutant in the gas stream.

99-183. (canceled)

184. A particle for use in air pollutant removal comprising a magnetic material and an oxidizing agent.

185-192. (canceled)

193. A method for use in removing pollutants from a gas stream, comprising:
introducing adsorbent magnetic particles into a gas stream, wherein each of a plurality of the adsorbent magnetic particles comprise strongly magnetic iron oxide and have a nominal diameter of about 50 microns or less, wherein the adsorbent magnetic particles associate with pollutants in the gas stream; and
removing the adsorbent magnetic particles associated with pollutants from the gas stream.

194-205. (canceled)

206. The method of claim 193, further comprising:
introducing magnetic oxidizing particles into the gas stream, wherein each of a plurality of the magnetic oxidizing particles comprise a magnetic material and an oxidizing agent, wherein the magnetic oxidizing particles oxidize elemental mercury in the gas stream to oxidized mercury; and
removing the magnetic oxidizing particles from the gas stream.

207-218. (canceled)

219. A system for use in removing pollutants from a gas stream, comprising:
a conduit for receiving a gas stream from a gas stream source;
a magnetic particle feeder operable to introduce adsorbent magnetic particles into the gas stream, wherein each of a plurality of the adsorbent magnetic particles comprise a strongly magnetic iron oxide particle with a nominal diameter of about 50 microns or less; and
a particle collector operable to remove the adsorbent magnetic particles from the gas stream after one or more adsorbent magnetic particles have associated with a pollutant in the gas stream.

220-223. (canceled)

224. The system of claim 219, further comprising:
a magnetic particle feeder for introducing magnetic oxidizing particles into the gas stream, wherein each of a plurality of the magnetic oxidizing particles comprises a magnetic material and an oxidizing agent, wherein the magnetic oxidizing particles oxidize elemental mercury in the gas stream to oxidized mercury, and wherein the particle collector is operable to remove the magnetic oxidizing particles from the gas stream.

225-240. (canceled)
